(19) United States
(12) Patent Application Publication
(10) Pub. No.: US 2021/0183227 A1
(43) Pub. Date: Jun. 17, 2021

(54) SOUND MONITORING SYSTEM

(71) Applicant: CONSERVATION LABS, INC., Brownsville, PA (US)

(72) Inventors: Mark Kovscek, Brownsville, PA (US); Tom Makovicka, Raleigh, NC (US); Paul Maiste, Jupiter, FL (US); Julie Hedrich, Palatine, IL (US)

(73) Assignee: CONSERVATION LABS, INC., Brownsville, PA (US)

(21) Appl. No.: 17/168,989

(22) Filed: Feb. 5, 2021

Related U.S. Application Data
(63) Continuation-in-part of application No. 15/276,496, filed on Sep. 26, 2016, now Pat. No. 10,914,055.
(60) Provisional application No. 62/233,131, filed on Sep. 25, 2015.

(51) Int. Cl. G08B 21/18; G10L 25/51; G10L 25/27; G06N 20/00

(52) U.S. Cl. CPC G08B 21/18; G10L 25/51; G08B 5/36; G06N 20/00; G10L 25/27

(57) ABSTRACT

Converting a sound to a sound signature and then interpreting the signature based on a machine learning analytical approach. Generally, “interpreting” means quantifying and classifying. A system for identifying statuses of one or more target objects may comprise a device for observing sounds comprising a sound detector, a housing affixing the sound detector on, or in the vicinity of a target object, a processor, a power supply, and a device interface. The system may further comprise a data transmitter, a remote server for receiving data from one or more devices for observing sound of a target object and/or the surrounding environment, a plurality of server-side applications applying analytical operations to the data, and a plurality of end-user devices for accessing the data through a plurality of user interfaces. The status identification system can be used to detect statuses and events of target objects.

### CROSS REFERENCE TO RELATED APPLICATIONS

This application is a Continuation-In-Part of co-pending U.S. patent application Ser. No. 15/276,496 which was filed on Sep. 26, 2016 and claims the benefit of U.S. Provisional Patent Application Ser. No. 62/233,131 filed on Sep. 25, 2015, the disclosures of which are incorporated herein by reference in their entireties.

### FIELD

The present disclosure relates generally to identifying statuses of target objects, for example fluid flow monitoring systems and more specifically, to connected systems for acoustically identifying statuses of target objects, such as observing water flow within a pipe or a network of pipes, or observing the operation and status of a machines, such as appliances like a washing machine. The disclosure also relates to detecting events, such as the maintenance needs of machines, leaks in a plumbing system, applying analytical methods to observed data, identifying consumption and water uses, as well as conservation opportunities.

### BACKGROUND

Creating insights from sound (e.g., the sound of water in a pipe, the sound made by a machine) is very difficult and typically requires the development of algorithms or models, for each unique observed object, event, or environment. That is, if there are “N” number of objects that generate sound, “N” sets of algorithms/models to interpret the sound would be created to provide accurate and actionable insights. Traditionally, this has been a very expensive and time-consuming exercise. For example, if there are N=1,000 machines or N=1,000 unique plumbing systems, then 1,000 algorithms must be developed to create accurate insights for the target object.

An aspect of the system described herein classifies and quantifies any sounds at scale by first creating a set of Base Models for a target object or category of objects in a pre-installation environment which is at least partially controlled. The Base Models are developed for major categories of the target object. In the case of water in a pipe (e.g., unique plumbing systems), the 1,000 unique plumbing systems may, for example, be represented by only three categories. A category might be ¾″ copper, ¾″ PEX, and 1″ copper. The Base Models are built for these major categories (N=1000, n=3). Next, the Base Models are then applied in an installed environment in conjunction with a listening device for observing sounds of and in the environment of the plumbing system. The Base Models are applied in conjunction with the listening device for a period of time to collect training data and baselining data on the sound emitted by the target object(s) and the environment. The system then uses the training data and baselining data to modify the Base Models through a development process to create Sensor Models. The development process generates device-specific models (which may also be called object-level models) which then go through a validation process to confirm their accuracy and appropriateness for the installation environment and circumstances. The validation process may also include a comparison to a standards database. Once validated the device specific models are then promoted to a repository as Final Sensor Models. Next, the Final Sensor Models are applied in the installed environment in conjunction with a listening device for observing sounds in continuous operation. Continuous operation of the Sensor Models includes periodic application of the validation process. If the Sensor Models do not pass validation, they are remediated through further modification, including through use of the various development processes applied to create the Sensor Models. If the Sensor Models need modification, the repository for Final Sensor Models are supplemented and updated. In the unlikely event that ongoing Sensor Model development through continuous operation does not satisfy the validation procedure, then the system may issue a notification that modification of Base Models are needed. If so, new or additional Base Models can be created in a pre-installation environment and the Base Models library is updated. The system may then apply the updated Base Models to create new device-specific Sensor Models in the installed environment and Final Sensor Models after validation is satisfied, and the process resumes in Continuous Operation.

The system described herein uses continuous machine learning techniques to develop, remediate and improve the Base Models and Sensor Models. Sensor Models are object-level, customized models to each sensor and configured for each object that the individual sensor evaluates in light of the event(s) targeted for observation and applicable environmental variables.

In one aspect, creating insights from sounds can be advantageous in commercial and residential plumbing applications. Commercial and residential plumbing is often located in difficult-to-see and difficult-to-reach locations. Plumbing may be between walls, underground (including sprinklers), or beneath a structure. Often times, the pipes within a plumbing system may develop a leak and the leak may go undetected for long periods of times, whether it be from the modest size of the leak (e.g. toilets and faucets), or because the leak is located in a location that a user rarely or never encounters (e.g. sprinklers). Leaky plumbing wastes natural resources and imposes unnecessary costs on the user. Additionally, leaky plumbing can result in structural property damage and hazardous biological growth. Lastly, municipalities and water authorities often require meters to be placed underground and/or external to the home making it more difficult for consumers to monitor water flow and identify or test for leaks.

In residential settings, users may encounter their water bill and face a quandary when they cannot locate the leak. Moreover, users are often times unsure whether the increased water usage is the result of a bona fide leak or whether the increase represents an accurate reflection of the user's increase in water use. At best, a user does not become aware of a potential problem until the end of their statement cycle, which may be at the end of a month, or an even longer period. At worst, a leak may go undetected until damage results, because a user believes the usage is normal.

In commercial settings, users may never detect a small leak if, for example, the aggregate use for a larger commercial building is sufficiently large that small fluctuations would not merit alarm.

Water delivery authorities rarely, if ever raise the issue of a leak, because they may be compensated for a user's increased usage. Thus, lacking the incentive to discover and diagnose leaky plumbing, the burden falls on the user/ratepayer, or another interest holder, such as an insurance company, which may be responsible for paying for damage incurred as a result of the undetected leak.

A scalable and extensible system to create insights from an object the emits sound may be applied to additional use cases. A system that classifies and quantifies sound has many unique properties. A sound wave can be described by five characteristics: wavelength, amplitude, time-period, frequency, and velocity. These characteristics create unique sound signatures that the human ear helps process to distinguish the type and nature of the sound through dimensions such as tone, pitch, volume, and quality. Similarly, the machine learning system disclosed herein quantifies the characteristics of sound and then analyzes those characteristics to create meaningful insights. Specifically, the system uses the unique characteristics of sound to classify and quantify the sound. The classification of the sound signatures means that the signatures are categorized and arranged into meaningful groups (e.g., a nominal scale). The quantification of sound means the signatures are assigned an interval or ratio scale such as a rate (e.g., gallons per minute for water, speed of a fan), volume, or likelihood (e.g., likelihood of failure) or an ordinal scale such as system health.

Use cases for this approach include assessing machine health and failure likelihood, categorizing human speech into groups (e.g., identify speaker, synthetic audio identification), assessing driving conditions (e.g., heavy traffic versus light traffic, presence of emergency vehicles or wet conditions), categorizing types of music (e.g., classical versus blue grass) and others.

Conventional devices and methods for detecting leaks may include the visual examination of unions known for leaks such as hot water heaters, toilets, bibs, welds, turns, or valves. Additionally, a user may employ the use of a moisture meter in suspected locations, or a user may conduct a trial-and-error process where valves are opened and closed starting from the furthest point “down” the line and working one's way “up” the line until the user believes they have isolated the branch of plumbing where the leak begins.

Beyond broken or leaky pipes, individual plumbing fixtures may leak or operate inefficiently as compared to other available alternatives. However, users typically have no concept of the water volume used by any particular fixture. This is because, for most end-users, physical flow meters are only located at one “upstream” location, which monitors aggregate water usage. Conventional water meters do little if anything to provide real-time or location specific flow rate data.

Attempts have been made to quantify flow at particular locations within plumbing system. Such devices typically take the form of an apparatus which must be placed in-line with the plumbing system. Such in-line applications often require manual calibration, and further may require adapters. Conventional flow rate measuring devices often have an analog or digital display which displays data only at the specific location of the device. Such conventional flow rate devices suffer from the limitation that they require invasive modification to a plumbing system, or if placed at the user-end of a system, interfere with the operation of a fixture and make for an unattractive appearance. In-line devices can also create additional opportunities for unwanted backups, clogs, and pressure losses.

Remote monitoring efforts, such as the use of ultrasonic sensors, have been made for observing fluid flow, but ultrasonic sensors tend be bulky, expensive, and may require significant training to operate. Additionally, this type of monitoring is sporadically used and does not offer long-term, real-time monitoring. Lastly, due to the cost and difficulty in operating, this type of monitoring is generally used for industrial applications.

There are other types of sensors that individually or as part of a system can classify and quantify the activity of an object. The challenge with these devices and techniques are cost and scalability. Examples of typical sensors include ultrasonic sensors, pressure transducers, and accelerometers. These sensors are not only costly, some of them require invasive procedures such as cutting a pipe, drilling into a machine, or opening up the machine. Non-invasive sensors such as microphones (e.g., MEMs microphones) create data to quantify and classify the activity of an object based on the sounds the object emits (e.g., the sounds of a washing machine indicate its activities and if the activities are normal or indicating failure). These sensors are easy to install and low cost. However, analytic methods are not accurate or scalable as many models have to be developed for each unique machine and environment. The system disclosed herein addresses the accuracy and scalability of algorithm development by building a combination of Based Models and Sensor Models where the system learns the unique environment and automatically adjusts the models at scale.

Accordingly, there is a need for a low cost, easy-to-use, non-invasive device, system, and method for observing real-time insights of a target object, collecting and interpreting data from the target object, and monitoring and analyzing the target object in an un-burdensome manner.

### SUMMARY

The following simplified summary is provided as a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect, the system is designed to create, validate, modify, and apply machine learning algorithms for creating insights from sounds. As used herein, the terms “model” and “algorithm” are interchangeable. Further, the system first creates category-level Base Models in a pre-installation environment in conjunction with a listening device resulting in a Base Model library, and thereafter applies Base Models from the library in conjunction with a listening device in an installed environment to create object-level Sensor Models. Sensor Models undergo a validation and remediation process and are repeatedly applied to create iterative self-improving Sensor Models to increase the overall confidence and predictability of the system

In one aspect, the fluid flow monitoring system comprises a network-connected pipe flow monitoring device, remote applications and infrastructure, and a user portal. The system may also employ a plurality of flow monitoring devices. The network may be a private network, or may be a public network, such as the internet. The applications may be hosted remotely to the flow monitoring device, such as on a computer within a private network, or for example, on a remote server accessed through a general internet connection. In one embodiment, the plurality of flow monitoring devices can be at one location. In another embodiment, the plurality of flow monitoring devices can be at different locations. The system may further comprise a plurality of user portals, wherein some portals are consumer portals and some are municipal water utility portals. In one embodiment, the plurality of user portals can be accessed at one location. In another embodiment, the plurality of user portals can be accessed at different locations.

In one aspect, the sound monitoring system comprises a network-connected sound-monitoring, or listening device at a single location or a plurality of sound-monitoring devices at multiple locations. A single listening device may use one microphone or a plurality of microphones. One microphone may be mounted on, or oriented toward the target (the sound emitting object) to detect sound made by the target (a contact microphone), while another microphone may be directed in an alternate orientation to detect sound made by the environment around the target object (an ambient microphone). For example, if the listening device is attached to a pipe, the contact microphone isolates the sound from the pipe while the ambient microphone captures environmental sound. Similarly is the listening device is attached to a machine, the contact microphone isolates the sound from the machine while the ambient microphone captures other, environmental sound.

In another aspect, the fluid flow monitoring system comprises a sound detector, and a housing for the sound detector, a signal processor, a microprocessor, a power supply, and a device interface. The signal processor may optionally be separate from the microprocessor, or the microprocessor may comprise a signal processor. The fluid flow monitoring system may further comprise a data transmission means, such as a wireless antenna or a data port. The fluid flow monitoring system may further comprise one or more remote applications, a plurality of user interfaces, and a notification system.

In another aspect, the sound monitoring system comprises a sound detector and a housing for the target sound detector, a temperature sensor, a signal processor, a microprocessor, a power supply, and a device interface. The signal processor may optionally be separate from the microprocessor, or the microprocessor may comprise a signal processor. When referred to generally as a “processor,” the term may refer to either a signal processor, or a microprocessor, or a combined signal and microprocessor. The sound monitoring system may further comprise a data transmission means, one or more remote applications, a plurality of sound monitoring devices, a plurality of user interfaces, and a notification system.

In one aspect, the fluid flow monitoring device comprises an audible sound detector. The audible sound detector may take the form acoustic-to-electric microphone or other sensors. Acoustic-to-electric microphones are well-adapted to the present invention because they are relatively inexpensive, and obviate the need for the implementation of more-expensive remote sensing technology such as ultrasonic sensors. Although the foregoing audible sound detector will be referred to generally as a microphone throughout the remainder of the disclosure, it should be noted that alternative devices or methods capable of sensing sound volumes (decibel or sound pressure level) and frequencies in the audible range may be eligible alternatives. In one embodiment, the frequencies are in the 12 hertz (Hz) to 20,000 Hz range. In another embodiment the frequencies are in the 25 Hz to 10,000 Hz range.

In one aspect, the sound monitoring device comprises an audible sound detector oriented toward the target object emitting a sound. This may be referred to the target or object microphone or target sound detector. In another aspect, the sound monitoring device comprises an ambient sound detector oriented away from the target object to detect ambient noise. The audible sound detectors used may take the form acoustic-to-electric microphone or other sensors. Acoustic-to-electric microphones are well-adapted to the present invention because they are relatively inexpensive and obviate the need for the implementation of more-expensive remote sensing technology such as ultrasonic sensors. Although the foregoing audible sound detector will be referred to generally as a microphone throughout the remainder of the disclosure, it should be noted that others devices or methods capable of sensing sound volumes (typically measured as decibel or sound pressure level) and frequencies in the audible range may be eligible alternatives. In one embodiment, the frequencies are in the 12 hertz (Hz) to 20,000 Hz range. In another embodiment, the frequencies are in the 25 Hz to 10,000 Hz range.

In one aspect, the microphone oriented toward the target is mounted or integrated into a frame or housing, which non-invasively attaches to the exterior of a plumbing fixture, such as a pipe. The microphone is oriented within the housing to detect sound characteristics, such as amplitude or loudness or frequency or all. In another aspect, the microphone is mounted to a washing machine where the contact microphone is oriented toward the machine to capture the sound characteristics for all machine function. In one embodiment, the amplitude or loudness can be detected across various sound frequencies. In another embodiment, the loudness is decibel based. In another embodiment, the loudness is sound pressure level based. The microphone housing may include or be made of sound blocking material and sound absorbing material, either, or both. The sound blocking and/or sound absorbing material is strategically placed within the housing to amplify desired sound characteristics for the microphone to sense it, and alternatively deaden certain undesired sound characteristics to avoid the microphone from sensing them, as the case may be. In one embodiment, the housing of sound blocking and/or absorbing material may be shaped to optimize the collection, amplification, or deadening of sounds. For example, a conical shape may be used to enhance the sound detected by the microphone.

In another aspect, the ambient microphone—that is oriented toward the environment, is also mounted on, or integrated into the housing of the device, and includes housing which may be optimally shaped to assist in the collection, amplification, or deadening of sounds.

In another aspect, the sound detector comprises a temperature sensor for sensing the ambient temperature. The temperature sensor may also be oriented to sensing the temperature of the target object (sound emitter). Alternatively, the device may include a plurality of temperature sensors for simultaneously sensing ambient temperature as well as the temperature of the target object.

In one aspect, a processor is connected to the microphone to process the signals created by the microphone. The processor may include one or more signal filters, which are capable of removing unwanted electronic signals from further transmission while further permitting the passage of other electronic signals. In one embodiment, the processor converts analog signals to digital signals. The processor may be preferably integrated into the microphone housing.

In one aspect, a processor may preferably organize and process the sound signals into computer-readable data. The processor may be instructed to apply a plurality of scoring algorithm and/or categorization algorithms or rules such as Base Models or Sensor Model to the data created by the processor when collected from the sound detectors. The processor may be preferably integrated into the microphone housing.

In one aspect, processor may be a single piece of hardware which serves both purposes of filtering and transmitting electronic signals and translating electronic signals to computer readable data, as well as applying algorithmic formulae and categorization rules to the data.

In one aspect, the flow monitoring device has a power supply. Said power supply can be powered from a battery or can be connected to the electrical system of a structure, such as a residence. Alternatively, the power supply may take the form of a solar based power source such as a solar panel or array connected to a power storage device, such as a battery or a plurality of cells.

In one aspect, the flow monitoring device or the sound monitoring device may have a device interface. The device interface may display or exhibit a plurality of statuses to the user as instructed by the processor. For example, the device interface may be a series of lights, each one of which illuminates to reflect the then-current status of the flow or sound monitoring device. For example, the processor may instruct a red light on the device interface to illuminate during a severely low or high flow situation, or upon the observation of a non-normal sound, sound signature, or detection of another alert event by the target object. Additionally, the device interface may have other indicator lights, the illumination of which may be adjusted or set by a user. For example, the user may set the flow monitoring device to have one status indicator illuminate when flows are observed between the range of X and Y, and may thereafter cause a second status indicator illuminate when the flow is between Y and Z, where Z may be greater Y, thus indicating an above-normal flow. As another example, (the inverse) the user interface of the flow monitoring device may be programmed to have both status lights illuminate when flow is between X and Y, and only have one status light illuminate when the flow is between W and X, where W is less than X, thus indicating a below-normal flow.

In one aspect, the sound monitoring device interface display may use lights or a digital display which reflects the status of a target object being monitored. In the case of a washing machine, for example, the device may illuminate a light reflecting “normal” operation, another light or color reflecting a “failure,” and another light or color reflecting ongoing normal operation, but nonetheless detecting a problem, and likely failure in the future. In the case of a digital display, the interface may show a graphical symbol or text reflecting the various statuses, such as cycle status, observed for the machine.

The device interface may optionally include a power or battery indicator which allows a user to identify whether power is coming from a battery or a main electricity. In the case of a battery, the power indicator may notify the user how much charge remains in a battery. The device interface may also have a wireless status indicator. Said wireless status indicator may indicate the status of the flow or sound monitoring devices' connectedness to a wireless data connection. The device interface may take the form of a plurality of lights, such as light emitting diodes (LED), or the device interface may take the form of a liquid crystal display (LCD), organic light emitting diode (OLED), or other type of computerized display. The device interface may also comprise an alarm. The alarm may sound when any predetermined criteria is met, such as the detection of a leak, pipe burst, no-flow circumstance, machine normal operation, machine failure, machine end of life, machine needing maintenance, low-battery or power disconnect, loss of data transmission, or other malfunction. The alarm may comprise a speaker, and the alarm may emit audible messages spoken in the language of the user. The device interface may also include a button or switch. In one embodiment, the button or switch can be used to reset, test, or calibrate the device interface, such as the indicator lights, or alarm, or both. In another embodiment, the button or switch is to turn the device on or off

In one aspect, the data transmission means of the flow monitoring device comprises an antenna capable of receiving or transmitting data over a network. The antenna may be connected to a wireless chip that handles the data received or transmitted by the wireless antenna. Collectively, the connected wireless antenna and chip components may be referred to as the wireless assembly. The wireless assembly may be capable of operating on a personal area network (e.g. Bluetooth), local area network (e.g. Wi-Fi), wide area network, or cellular network. The wireless antenna is not restricted to the transmission technologies recited herein and may comprise any technology which transmits information wirelessly, via a communication channel, such as radio frequency (RF) or microwave transmission, and may include other technologies such as satellites

In one aspect, the flow monitoring device comprises a data port. The data port may be a universal serial bus (USB) port. The data port may optionally be another type of data port, such as a Thunderbolt port, a Lightning port, Ethernet port, or a proprietary port of a different type. The data port allows a user to attach peripherals to the flow monitoring system. For example, a user may attach a computer to the flow monitoring device via the data port. The device may transmit data to the computer regarding the operation of the microphone transducer. Additionally, a user may use the port to calibrate, set, or maintain the performance and data monitoring settings and characteristics of the device. For example, the data port may be used by a user to program the behavior of the device interface, such as the lights or alarm

In one aspect, the data transmission means of the flow monitoring device comprises a wired network cable. The network cable may be hard-wired to the flow monitoring device as a primary means of data transmission, or as a back-up redundancy. The use of the network cable may also be needed for maintenance or diagnostics by a user or service technician. The network cable may comprise any technology for transmitting data through a wire, including but not limited to Ethernet cables, universal serial bus (USB) cables, coaxial cables, or other fiber optic cables.

In one aspect, the flow monitoring device comprises a base to which the data is sent wirelessly. The base may be referred to as a base or a base station. The base is internet-connected and physically located remotely relative to the flow monitoring device. The base may comprise a generic Wi-Fi router or internet gateway. Alternatively, the base may comprise a proprietary base station which is connected to a Wi-Fi router or a hard-wired internet connection. The base may also be a cellular connection, such as a hot spot. The base is capable of simultaneously communicating with a plurality of flow monitoring devices. Thus, the base serves as a hub for the data transmitted among the plurality of flow monitoring devices. The base transmits data to a server via the internet. In one embodiment, the server can include infrastructure and applications to support the disclosed system and may be referred to as a server-side application.

In one aspect, wireless data transmission efficiency is optimized to reduce bandwidth usage by varying periodicity. In one aspect, continuous data transmission could use as much as 30 MB per day. In another aspect, optimized data transmission could use less than 40 kb per day. Use of less bandwidth allows for use of less energy intensive transmission protocols and protocols with longer or better range which may have bandwidth thresholds and which may be better suited for low-power usage applications. The data transmission reduction method disclosed herein uses one or more algorithms to determine at the device level, whether an event has occurred meriting transmission. For example, in the case of a fluid monitoring device placed on a pipe, the algorithm may instruct the device not to transmit data to the cloud, for the device to stay in a sleep mode, unless a water event is detected. In the event a water event is detected, then the algorithm applies additional management analyses to determine the frequency of continuous operation and the amount of data to be transmitted to the cloud for further application of Sensor Models.

In one embodiment, the flow monitoring device is connected to a water shutoff device, or another intervention instruction, if the sound detector application is something other than water, wherein upon the detection of a predetermined threshold (e.g., an emergency event), the sound monitoring device instructs the shutoff device to close or trigger the intervention signal. In the case of water, the shutoff device would activate a valve and prevent water from further entering the plumbing network downstream of the shutoff device. In the case of a washing machine or other machine, the device may instruct the machine to enter a shut down or power cycle.

According to an aspect, the sound monitoring system comprises a local application loaded on to a computer-readable storage medium on the sound monitoring device. The local application may have Base Models and Sensor Models comprising data management and analysis capabilities that, in conjunction with the computer-readable storage medium, can store, organize, and process the data gathered by the microphones and processed by the signal processor and/or microprocessor. The data management system of the local application may apply one or more Base Model or Sensor Model algorithms or categorization rules to interpret or categorize the data. The local application may then cause the device interface to exhibit one or more particular notifications upon the happening of an event, whether through the exhibition of a status indicator light, the manipulation of a display, or the sounding of an alert.

In one aspect, the sound monitoring system comprises remote applications and backend infrastructure running on a computer-readable storage medium, including optionally using public or private cloud servers. The backend infrastructure has data management and analysis capabilities that create, modify, validate, and apply, in conjunction with computer-readable storage medium, can preferably store, organize, and process the data transmitted to it from the sound monitoring device via the internet. The data management capabilities of the backend infrastructure and remote applications may carry out the foregoing tasks regardless of connectivity method with the flow monitoring device, whether via Bluetooth, internet, cellular, near-field communication, microwave, satellite, television signal white space, or otherwise. The data management system for the remote applications may apply one or more Base Model or Sensor Model algorithms or categorization rules to interpret and categorize the data. The data management system may support a sound prediction improvement engine, wherein the application periodically updates and changes the models or algorithms applied to the data after validation and remediation processes so as to increase the level of predictability and confidence, while filtering outlying data. The data management system may conduct a plurality of analyses, including time-sensitive sound calculations and conservation routines. In another embodiment, the remote applications simply allows the various processes to “speak to each other”.

In one embodiment, the remote applications and backend infrastructure are connected to a shutoff device or can send another intervention instruction, wherein upon the detection of a predetermined threshold (e.g., an emergency event), the remote applications and backend infrastructure instruct the shutoff device to close or otherwise trigger the intervention instruction. In the case of a plumbing system, a valve would close to prevent water from further entering the plumbing network downstream of the shutoff device. In the case of a machine, it may instruct the machine to stop all processes, or to enter a shut down cycle.

In one aspect, the backend infrastructure enables one or more user portals through server-side and client-side applications. The user portals further comprise a user interface displayed on an electronic display. A user may access the user portal over the internet by logging into a website, using desktop application, or by using a mobile application. The one or more user portals may employ a plurality of portal categories. For example, one user portal may be for a municipal water utility to log in and access a municipal water customer's observed data. The utility user portal may optionally observe aggregate data collected by a plurality of customers. By way of another example, another user portal may be for a customer, wherein the customer may access and observe the data from its system, but is prohibited from observing the data or aggregate data of systems belonging to other customers. In another embodiment, a customer can compare its personal data to anonymously compiled data from other users. In another embodiment, a customer can compare its personal data to data compiled from a specific cohort. The cohort may be based on geography, household size, company size, or all other persons using the flow monitoring device.

In one aspect, the user portal comprises a plurality of options for system configuration, data observation, system warnings, and system recommendations. The system configuration options allow a user to input additional characteristics applicable to specified data. For example, a user can monitor a single pipe at the point of entry, e.g. at the meter, of a single location. Alternatively, a user can monitor multiple pipes at a single location. For example, if a user knows that one dataset is coming from a flow monitoring device located on a pipe in a residential kitchen, then the user may use the user portal to name the device and may instruct the server-side application to apply analyses germane to plumbing flow characteristics often found in kitchens. Employing such location and application-focused algorithms and analyses allows a user to quantify their data relative to other locations and applications. By way of another example, if the user knows another dataset is coming from a flow monitoring device placed on its irrigation system, the user could log in through the user portal and configure the device to apply appropriate algorithms and analyses to this dataset with would be more appropriate for irrigation plumbing. In the event a user's system comprises a plurality of monitoring devices, the portal may optionally allow a user to develop or observe a map, or branching tree, of its system. Thus a user may be able to quantify the volume of water used in respective branches of its system. If, for example, the sum of branch-observed flows is less than the aggregate-observed upstream flow, such may indicate the existence of a leak. In another aspect, the system can be configured to identify the characteristics of the location such as the size, number of users, number of water using appliances (e.g. toilets, sinks, showers, tubs, dishwasher, washing machines, heating and cooling units, etc.).

In another example, the sensor may be attached to a washing machine to generate insights about the state of the machine function, its health, and likelihood of failure. In a commercial setting, the sensor can indicate the number of times a machine is used, the setting that were selected, and provide real-time information about the usage of the machine. Further, the application can report the health of the machine, the aspects of the machine that may cause failure, and the likelihood of failure. These insights may be used to create value ranging from load balancing, reduced or optimized service calls, increasing machine uptime, and improving machine energy efficiency, among others.

Once configured, the device and backend system, may identify such a discrepancy, and deliver a notification to the user via the user portal. The user portal may also comprise a notification system. The user may log into the user portal and specify certain events which would trigger a notification. Such notifications could reflect positive or negative data benchmarks. For example, if a user's system includes data from a flow monitoring device located on a residential plumbing system a user may instruct the user portal to issue a positive notification every time it detects a shower lasting less than a specified period of time (say for example, 7 minutes), or using a volume of water less than a specified volume. So as to avoid false notifications, the user portal may be set to withhold notifications unless data reflects flow lasting at least a specified period of time (say 2 for example, 2 minutes). The notification system may alternatively be configured through the user portal to issue negative notifications, or warnings. For example, the notification system may be configured to issue a warning notification when the data observes slow, but constant flow, indicating a slow leak. Alternatively, the notification system may be configured to issue a warning when flows within a system are observed as extremely volatile, indicating a failing component, such as a pressure regulator. The notification system may be configured to issue a warning when a particular branch within a system observes prolonged periods of high flow, indicating that a fixture has been left in the open position, or that there is a substantial plumbing rupture.

In one aspect, the notification system may be accessible by both a customer and a municipal water utility. The notification system may be set differentially, such that certain notification events notify a user, whereas other notification events notify the utility. For example, if a plurality of customer monitors reflect normal flow at a certain point, but low or no flow universally thereafter (later in a branch, or “downstream”), such would reflect the potential for a water main line obstruction or break at a location in between the high and low pressure zones. Thus, while the notification system may notify a customer simply that their municipal water service has been interrupted, it may also notify the utility with more specific information about the potential zone of obstruction.

In one aspect, the notification system can provide information to the customer and utility about water usage for a variety of different situations. For example, the information can be provided as a daily, weekly, or monthly reports on water usage. Alternatively, the information can be provided based on the time of day and water appliance. The information can provide the customer valuable insights as to its water usage. The information can also provide analyses of the water usage that may reveal areas where water usage can be reduced.

In one aspect, the notification system may alert the user of overconsumption and the potential for costs incurred with overconsumption. Some climates may be subject to drought conditions such that governmental entities institute mandatory usage reductions or water rationing schemes. Users unable to meet the mandatory reductions may face significant penalties. Users unable to operate within the rationing criteria may experience water outages. Thus, the notification system can be configured to provide continuous or intermittent status updates informing a user that their water usage conforms to reduction mandates or rationing criteria. Alternatively, the notification system may notify a user that their water volume usage deviates from said reduction or rationing criteria and will project the likely surcharge consequences (in the case of mandated reductions) or the date of expected water outage (in the case of water rationing).

In one aspect, the notification system may alert users through a plurality of media or data transmission modes. For example, the notification system may notify a user of a particular monitoring device's status, or in the case that a plurality of monitoring devices are deployed, the notification system may notify a user of the overall status of larger system characteristics via email, text messaging, or automated telephone dialing. A user may configure their preferred mode or modes of notification through the interface of the user portal.

With respect to the present disclosure, a method for observing sound is provided. The method comprises a step of placing a sound monitoring device on or in the vicinity of a target object (sound emitter), wherein the sound monitoring device includes an audible sound detector oriented toward the target, and at least a second ambient audible sound detector in a second orientation, temperature sensor a processor, a data transmitter, a power supply, and a device interface; a step of measuring audible sound; a step of processing the sound to computer readable data through a processor; a step of the processor applying one or more algorithms to the computer-readable data, wherein the algorithms comprise one or more of Base Models or Sensor Models and a step of exhibiting the resultant data on the device interface. In one embodiment, the exhibited data may indicate water flow status. In another embodiment, the exhibited data may indicate the operational status of a machine. In another embodiment, the exhibited data may indicate an alert. In another embodiment, the displayed data may indicate a leak. In another embodiment, the displayed data may indicate a broken pipe. In another embodiment, the displayed data may indicate ways to conserve water usage.

In one aspect, the method disclosed herein may comprise a step of placing a sound monitoring device on the exterior of a pipe or in the case the target object is not a pipe, a step of placing the sound monitoring device on or in the vicinity of the target object. The sound monitoring device includes an audible sound detector, a microprocessor, a data transmitter, and a power supply. The method also comprises a step of measuring audible sound emitted by the target object, for example through the pipe, with the sound monitoring device; a step of processing the sound to computer readable data through a processor; a step of transmitting the data to a remote server on a public or private cloud having a storage medium holding one or more server-side applications; a step of applying one or more algorithms—Base Models and/or Sensor Models—on the device or supplied by the server side application to the data, a step of making the resultant data, analysis, usage, performance, status, maintenance information and notifications available to a user or administrator via a user portal.

In one aspect, the system and method disclosed herein may employ a sound monitoring device wherein the sound monitoring device includes an audible sound detector oriented toward the target object (a target mic) and an audible sound detector in a second orientation for detecting ambient or environmental sounds (an ambient mic).

In one aspect, the method for monitoring pipe sound may comprise the foregoing steps, wherein the sound monitoring device further comprises a signal processor. The signal processor may interpret acoustic signals and convert them to digital signals. The signal processor may apply one or more filters to the acoustic signals to enhance the signals desired to be observed, and to eliminate those signals where observation is either unneeded or undesired. The signal processor may be separate from, or integrated within the microprocessor. The microprocessor may alternatively carry out the signal processor's tasks.

In one aspect, the method for monitoring pipe flow may comprise the foregoing steps, wherein the algorithm—the Base Models and/or Sensor Models—applied by the microprocessor of the flow monitoring device further comprises an algorithm that analyzes flow rate as a factor of time.

In one aspect, there are three major steps in the machine learning process. First, Base Models are developed on training data, see FIG. 14. The algorithms are developed from major categories of the target object. In a plumbing environment, these categories are primarily defined by pipe size and material. In a mechanical system, these categories may be defined by size of the equipment or the number of equipment features. A typical target object has about 5 major categories. A second step is Sensor Model creation, which is developed based on training data collected for each installed sensor, see FIG. 15. A third step is continuous operation, which continually iterates and self-corrects, but may optionally include refinements based on user input.

In one aspect, there are two general analytic processes that develop the Base Models and Sensor Models. The first step for either are Development Model approaches, which are methods and algorithms that assess, categorize, and weight input sound data for entire classes of a target object. A second step for creating Base Models or Sensor Models are Production Model approaches, which are models that create algorithms to quantify and classify behaviors for an entire class of a target object. Whether in the context of a Base Model or a Sensor Model, Development Models are used to inform or create Production Models. Production Models are improved and finalized for machine learning production or operations.

In one aspect, the method for monitoring pipe flow may comprise the foregoing steps, as well as a further step of connecting a plurality of flow measuring devices to the internet.

In one aspect, the method for monitoring the sound of a target object may comprise the foregoing steps, as well as a further step of connecting a plurality of sound measuring devices to the internet.

In one aspect, the method for monitoring pipe flow or other sounds emitted by a target object may comprise the foregoing steps, as well as a further step of sending one or more notifications to one or more users. The notification event may occur upon the data reflecting a specified triggering benchmark, such as high, or low flow measured as a factor of time. In another aspect, the sounds emitted by a machine may indicate an imminent failure or the likelihood of a failure in a prescribed number of days. A notification may also occur upon a triggering event wherein a plurality of data sets indicates a relational performance characteristic, such as disparate flow rates in different branches of the system. In the use case of monitoring machines, sensors may be placed on all washing machines in a commercial laundry facility where machine health and failure likelihood on the fleet of machines will inform optimized maintenance and service calls.

In one embodiment, the method for monitoring pipe flow or other sounds emitted by a target object may further comprise a step of connecting either the sound monitoring device or the remote applications and backend infrastructure to a shutoff device, wherein upon the detection of a predetermined threshold (e.g., an emergency event), the sound monitoring device instructs the shutoff device to close. In the case of a plumbing system, a valve closes and prevents water from further entering the plumbing network downstream of the shutoff device.

In one embodiment, the sound monitoring system is operated and maintained by an end user. In another embodiment, the end user subscribes or leases the sound monitoring system from a service provider.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a perspective view of an embodiment of a sound monitoring device of the present disclosure, mounted to a pipe.

FIG. 1A is a plan view of an alternative embodiment of the contact side of the coupler housing of the sound monitoring device of the present disclosure.

FIG. 1B is a perspective view of the embodiment of FIG. 1A with the sound chamber for the contact microphone seated into the coupler housing.

FIG. 1C is a perspective view of the embodiment of FIG. 1A with the sound chamber for the contact microphone exploded from the coupler housing.

FIG. 1D is a profile view of the embodiment of FIG. 1A, cut through line A-A.

FIG. 1E is a magnified detail view of section A of FIG. 1D.

FIG. 1F plan view of an alternative embodiment of the ambient side of the coupler housing of the sound monitoring device of the present disclosure.

FIG. 1G is a perspective view of the embodiment of FIG. 1F with the sound chamber for the ambient microphone exploded from the coupler housing.

FIG. 1H is a profile view of the embodiment of FIG. 1F, cut through line A-A.

FIG. 1I is a magnified detail view of section F of FIG. 1H.

FIG. 2 is a perspective view of an alternative embodiment of a sound monitoring device of the present disclosure, with a sound isolating material exploded to reveal a sound detector connected to a housing and mounted to a pipe.

FIG. 3 is a perspective view of an alternative embodiment of a sound monitoring device of the present disclosure, with a sound isolating material enveloping a sound detector connected to a housing and mounted to a pipe.

FIG. 4. is a non-limiting example of a schematic illustration of a system for monitoring fluid flow, collecting data, organizing and interpreting data, transmitting data via a transmission network, displaying the data, and alerting the user to certain data patterns, trends and benchmarks.

FIG. 5 is an embodiment of a user interface for a system for monitoring fluid flow of the present disclosure. The embodiment of FIG. 5 identifies an exemplary summary overview for a month's worth of data monitored by the system.

FIG. 6 is an embodiment of a user interface for a system for monitoring fluid flow of the present disclosure. The embodiment of FIG. 6 identifies an exemplary line-chart reflecting daily fluid flow data over time, as monitored by the system.

FIG. 7 is an embodiment of a user interface for a system for monitoring fluid flow of the present disclosure. The embodiment of FIG. 7 identifies an exemplary summary overview for a month's worth of data monitored by the system, categorized by figure type and graphically illustrating the amount of water used by each fixture throughout that month. The embodiment of FIG. 5 further identifies a graphical comparison layer, illustrating water use by each fixture throughout that month, comparative to other data sets.

FIG. 8 is an embodiment of a user interface for a system for monitoring fluid flow of the present disclosure. The embodiment of FIG. 8 identifies an exemplary summary overview for a day's worth of data monitored by the system, categorized by volume and time of the day, graphically illustrating the amount of flow measured throughout various times of the day through a line-chart. The embodiment of FIG. 8 further reflects a graphical comparison layer of line-chart, illustrating flow volume throughout the times of the day, comparative to other data sets.

FIG. 9 is an embodiment of a user interface for a system for monitoring fluid flow of the present disclosure. The embodiment of FIG. 9 identifies an exemplary summary overview for a month's worth of data monitored by the system, categorized by fixture and volume of flow, comparative to times of the day, graphically illustrating the amount of volume used by various fixtures at times of the day.

FIG. 10 is an embodiment of a user interface for a system for monitoring fluid flow of the present disclosure. The embodiment of FIG. 10 identifies an exemplary summary overview for a year of data monitored by the system.

FIG. 11 is an embodiment of a user interface for a system for monitoring fluid flow of the present disclosure. The embodiment of FIG. 11 identifies an exemplary configuration page for managing user-input settings governing the system.

FIG. 12 is a non-limiting example of an illustration of a statistical analysis performed on data collected by an acoustic flow rate observation device.

FIG. 13 is a non-limiting example of an illustration of statistical analysis performed on data collected by an acoustic flow rate observation device.

FIG. 14 is a non-limiting example of a schematic illustration of a method for creating Base Models for use in the sound monitoring system.

FIG. 15 is a non-limiting example of a schematic illustration of a method for creating Sensor Models for use in the sound monitoring system.

FIG. 16 is a non-limiting example of a schematic illustration of a method for the continuous operation of sound monitoring system using Sensor Models.

FIG. 17 is a non-limiting example of a schematic illustration of a method for reducing data in the sound monitoring system.

FIG. 18 is a non-limiting example of a table illustrating frequency weighting outputs as used in the system.

FIG. 19 is a non-limiting example of a table illustrating the relationship between the cluster assignment and the classification assignment as used in the system.

FIG. 20 is a non-limiting example of a table illustrating Production Model outputs.

FIG. 21 is a non-limiting example of a series of sound signatures correlated with their corresponding target event.

### DETAILED DESCRIPTION

The features of the present disclosure may be created by using one or more distinct parts and associated components which, when assembled and connected together form the disclosed sound monitoring system regardless of the particular form. Unless defined otherwise, all terms of art, notations and other scientific terms or terminology used herein have the same meaning as is commonly understood by one of ordinary skill in the art to which this invention belongs.

In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.” As used herein, the term “user”, “subject”, “end-user” or the like is not limited to a specific entity or person. For example, the term “user” may refer to a person who uses the systems and methods described herein, and frequently may be a field technician. However, this term is not limited to end users or technicians and thus encompasses a variety of persons who can use the disclosed systems and methods.

The sound monitoring devices, systems, and methods described herein can now be better understood turning to the following detailed description. It is to be expressly understood that the illustrated embodiments are set forth as examples and not by way of limitations on the embodiments as ultimately defined in the claims.

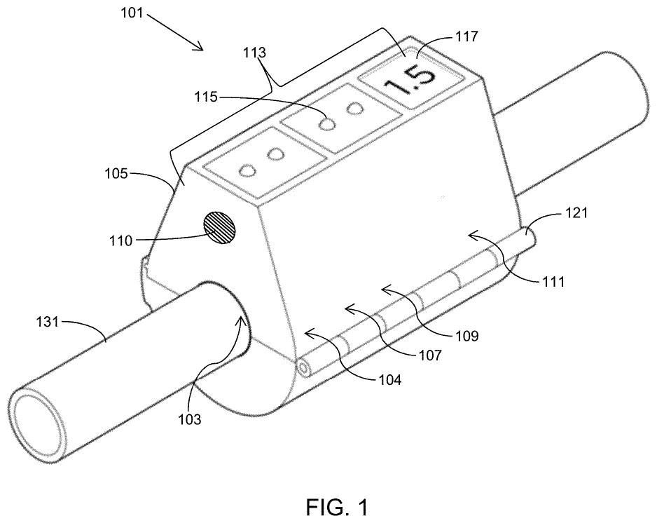

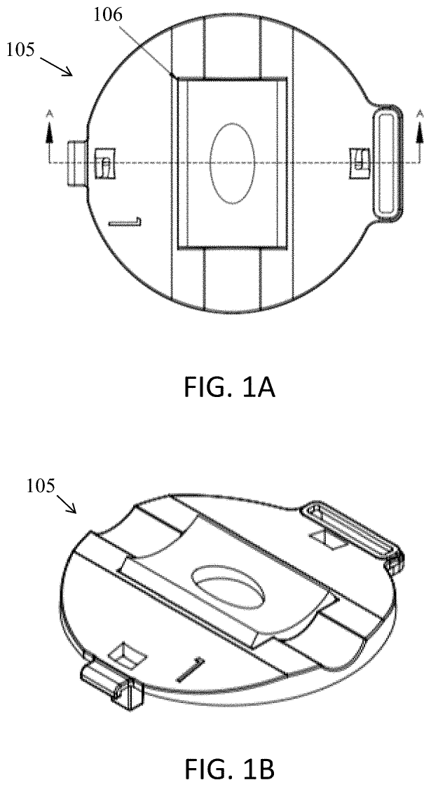

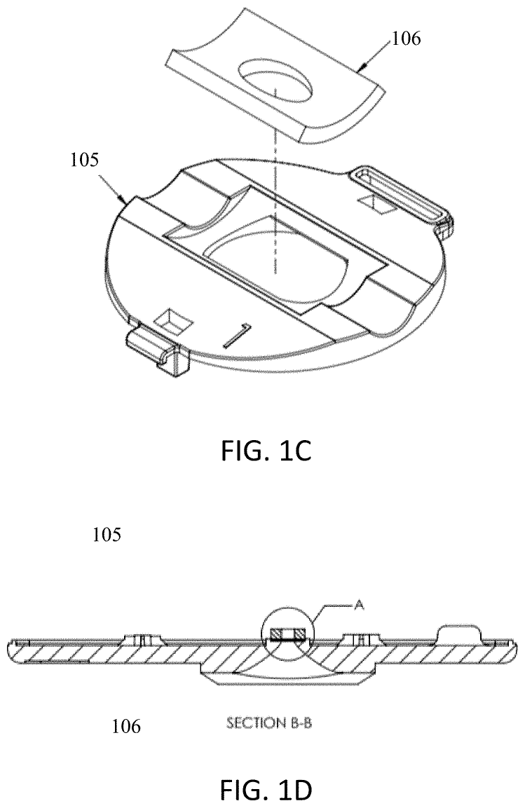

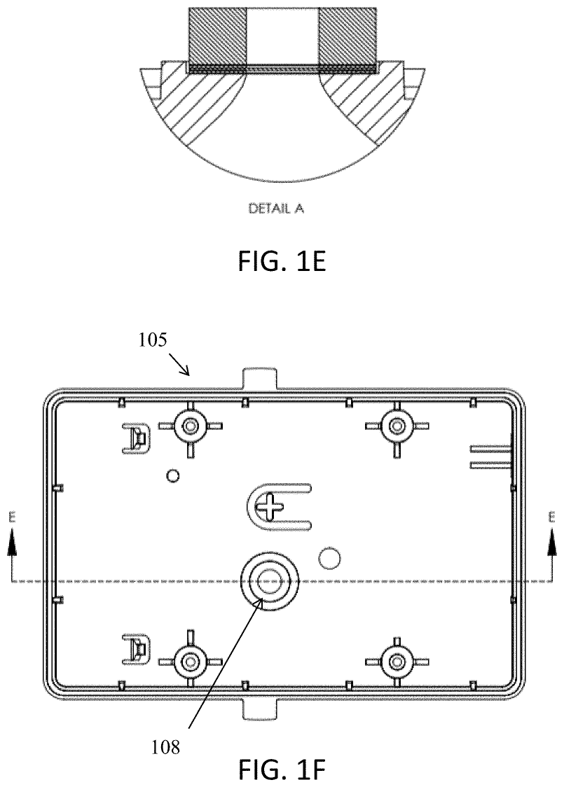

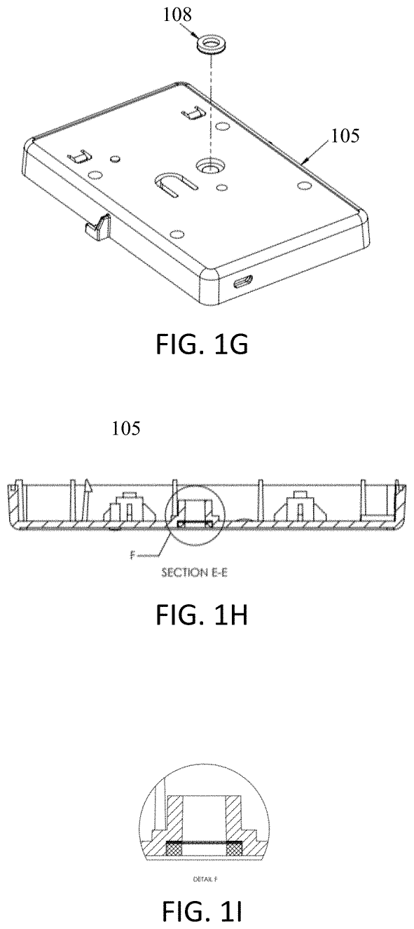

FIG. 1 is a perspective view of an embodiment of a sound monitoring device 101 of the present disclosure, mounted to the exterior of a pipe 131. The housing 105 of sound monitoring device 101 is visible. On the top of the housing 105, a device interface 113 is provided. In the present embodiment, device interface 113 contains both a series of lights 115 as well as a visual digital display 117. In the present embodiment, the housing 105 envelops and affixes to the exterior of the pipe 131 through the use of a hinge 121 which permits an upper and lower portion of the housing to be detachably connected to one another. Internal to the housing 105 of the sound monitoring device 101, is a sound detector (103)(not visible), sound-blocking material (not visible), sound-absorbing material (not visible) (sound-blocking and sound-absorbing material may be referred to alternatively or collectively as sound-isolating material), a power supply such as a battery (111)(not visible), a data transmitter (121)(not visible), a signal processor (107)(not visible), and a microprocessor (109)(not visible). Also mounted on the housing 105 of the flow monitoring device 101 is an alarm 110, which, in operation can emit either a siren, or pre-recorded language-driven announcement.

FIG. 1A is a plan view of an alternative embodiment of the contact side of the coupler housing 105 of the sound monitoring device of the present disclosure.

FIG. 1B is a perspective view of the embodiment of FIG. 1A with the sound chamber 106 for the contact microphone seated into the coupler housing. The sound chamber 106 may be a sound blocking and/or sound isolating material. Here the coupler 105 and the sound chamber 106 are shaped to be mounted on the exterior of a pipe, which lays in the center channel of the housing coupler.

FIG. 1C is a perspective view of the embodiment of FIG. 1A with the sound chamber 106 for the contact microphone exploded from the coupler housing. The sound chamber has an aperture through which sound is channelized or focused toward the microphone. The walls of the aperture may be shaped at an angle to magnify the sound observed, so that the aperture opening on the side in contact with the target is larger than the side closer to the mic, like a cone.

FIG. 1D is a profile view of the embodiment of FIG. 1A, cut through line A-A. This demonstrates the upwardly and inwardly curved and sloping sound chamber 106.

FIG. 1E is a magnified detail view of section A of FIG. 1D. This demonstrates the upwardly and inwardly curved and sloping sound chamber 106 with greater effect.

FIG. 1F plan view of an alternative embodiment of the ambient side of the coupler housing 105 of the sound monitoring device of the present disclosure.

FIG. 1G is a perspective view of the embodiment of FIG. 1F with the sound chamber 108 for the ambient microphone exploded from the coupler housing. Here, the sound chamber 108 is not formed to magnify or focus sounds from the environment.

FIG. 1H is a profile view of the embodiment of FIG. 1F, cut through line A-A. The non-magnifying sound chamber 108 is also in view.

FIG. 1I is a magnified detail view of section F of FIG. 1H. The non-magnifying sound chamber 108 is prominent here.

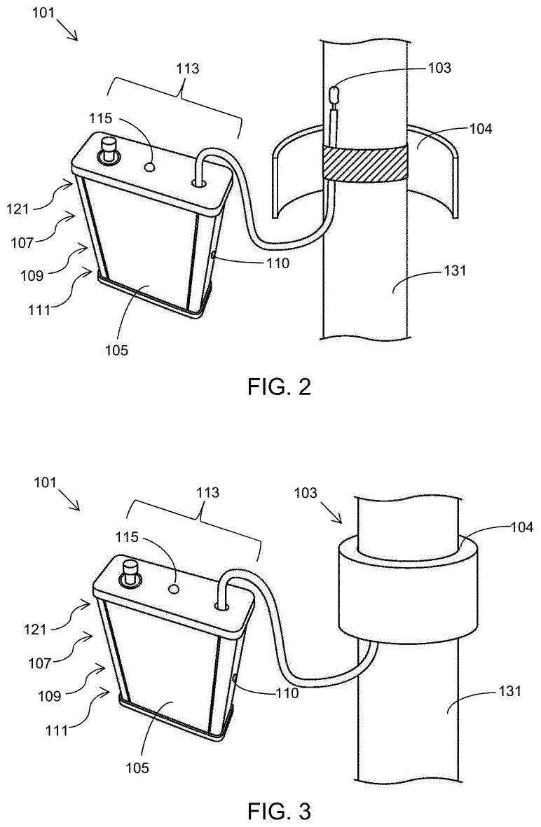

FIG. 2 is a perspective view of an alternative embodiment of a sound monitoring device 101 of the present disclosure, with a sound isolating material 104 exploded to reveal a sound detector 103 connected to a housing 105 and mounted to a pipe. In this embodiment, the sound detector is not integrated within the housing 105, but instead is connected to the housing 105 by a wire, so that the housing may be placed at some distance from the area of the pipe 131 monitored. Such an arrangement can provide an advantage to the user where a pipe is in a hard-to-reach location, such as under a floor board or next to a wall, but still permits a the use of the present invention to observe fluid flow through the pipe 131. When prepared to observe fluid flow, the sound detector 103 is enveloped by sound isolating material 104 (As seen in FIG. 3) which can comprise of either sound blocking material, or sound absorbing material, or both. Sound isolating material 104 may be any material which lessens or prevents unwanted sounds from reaching the sound detector 103. However, in the present FIG. 2, the sound isolating material 104 is exploded to reveal the flow monitoring device 101 mounted to the pipe 131. A device interface 113 is provided on the housing 105. In the present embodiment, device interface 113 includes a light 115 and an audible alarm 110. Internal to the housing 105 of the flow monitoring device 101, is a power supply such as a battery (111)(not visible), a data transmitter (121)(not visible), a signal processor (107)(not visible), and a microprocessor (109) (not visible).

FIG. 3 is a perspective view of an alternative embodiment of a sound monitoring device 101 of the present disclosure as seen in FIG. 2, but the sound isolating material 104 is envelops the sound detector 103 connected to a housing 105 and mounted to a pipe 131. All other features are similarly shown as seen in FIG. 2.

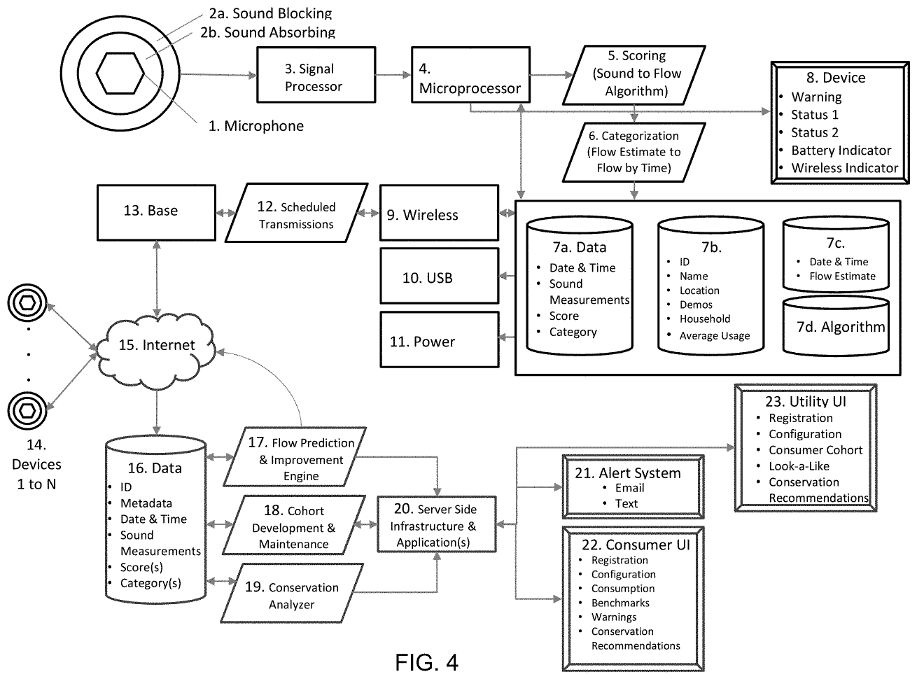

FIG. 4 depicts a schematic illustration of a system for monitoring fluid flow, collecting data, organizing and interpreting data, transmitting data via a transmission network, displaying the data, and alerting the user to certain data benchmarks and water consumption patterns. With respect to FIG. 4, an audible sound detector is provided as microphone 1 within the system. Microphone 1 of FIG. 4 is the same element of the present disclosure as sound detector 103 of FIGS. 1-3. The audible sound detector, e.g. microphone 1, is capable of detecting sound in the audible frequency, which is roughly 12 hertz (Hz) to 20,000 Hz. In one embodiment, the audible frequency is from 25 Hz to 10,000 Hz. Microphone 1 is represented as affixed to a water pipe (see 131 of FIGS. 1-3) by a housing (see 105 of FIGS. 1-3) which also contains sound blocking material 2a (e.g. mass loaded vinyl) and sound absorbing material 2b (e.g. melamine foam). Sound blocking material 2a and sound absorbing material 2b of the embodiment of FIG. 4 are represented as sound isolating material 104 of FIGS. 1-3 and may be generally referred to as sound-isolating material. The microphone 1 is connected to a signal processor 3 to process the audible sound signals detected by the microphone 1. The signal processor 3 may apply one or more filters to the sound signals in processing the signals into computer-readable data and sending the data to a microprocessor 4. The microprocessor 4 analyzes, organizes, and processes the data received from the signal processor 3. The microprocessor 4 has been configured to apply a particular instruction set to the data, wherein said instruction set comprises a plurality of algorithms. One algorithm applied to the data by microprocessor 4 is a scoring algorithm 5 which estimates volumetric water flow based on the sound data. The microprocessor 4 then applies a categorization algorithm 6 to the scoring data, which organizes the scoring data into a dataset organized as a function of volume over time. The microprocessor 4 then stores to a computer-readable storage medium, the observed and calculated data, e.g., flow rate data 7a, metadata 7b, and benchmarks 7c. The flow rate data 7a, as discussed above, includes information related to date, time, sound measurements collected, scoring, and categorization. Categorization includes flow-level categories (e.g., an interval scale for low to high fluid flow) as well as categories based on “flow signatures” to indicate the use of a particular device or use (e.g., toilet, shower, dishwasher, washing machine, sprinkler, etc.). Various water-using devices have a “flow signature” based on the velocity and duration of the water flow in the pipe. In one embodiment, the flow signature can be developed and refined per water-using device per location. In another embodiment, base line flow signatures for certain devices can be estimated based on collective data. For example, a standard flow signature for a toilet can be 1.1 gallons per minute for 90 seconds or 3.25 gallons per minute for 30 seconds or similar.

Metadata 7b includes user-supplied information related to the device ID, given name, physical or relational location, demographics, aggregate (such as household) information, and information averages. The stored metadata can also be used to configure the device for optimal water flow monitoring. Benchmark data 7c, is organized to establish benchmarks as a function of time (such as flow rate during particular months, days or peak times, or as compared to households or entities with similar consumption patterns), and for forecasting usage and identifying anomalous usage in light of said benchmarks, including data and benchmarks defining water appliance usage. A device interface 8 (seen as 113 in FIGS. 1-3) is connected to the microprocessor 4.

Various statistical methods (e.g., regression, GLM, Tweedie, etc.) and analytics generally fitting the category of machine learning are used to quantify the relationship between the sound measurements and the water flow in the pipe. A Development Model includes a scoring algorithm and is created as a baseline to determine the contribution of the sound frequency (e.g., hertz) and energy measurements (e.g., decibels) to the water flow estimation as well as performance benchmarks for various predictive statistical methods. Production Models are the algorithms that are physically stored on the computer-readable storage medium of the device or in the cloud for by-device flow estimation. Production Models use the Development Model as a performance baseline; Production Models may employ other or additional statistical methods and include more or less frequency measurements and other independent variables such as demographics, household data, and location.

The device interface 8 includes a plurality of lights (seen as 115 of FIG. 1), including a warning light, a first status light, a second status light, a battery status indicator, and a wireless status indicator. The warning light can, for example, be configured to illuminate upon an event indicating pipe leakage. The two status lights can, for example, be configured to illuminate when there are no problems detected, such that one or both status lights are on to function a “normal” status. Alternatively, the status lights may be configured to operate independently, such that different combinations of their illuminated statuses reflect modest underperformance, or over-performance. The power or battery indicator may be configured to reflect connection to a power source or a battery charge. For example, it could be configured to stay illuminated when the battery is strong and configured to flash when the battery is weak. A wireless status indicator is also depicted. This indicator may be configured to behave in a manner reflecting wireless connection status. For example, the indicator may be configured to remain off when it does not detect a wireless network. The indicator may flash when in a pairing/connecting mode. The indicator may remain illuminated while a wireless connection is maintained. A wireless transmitter 9 (data transmitter 121 of FIGS. 1-3) is connected to the microprocessor 4 and microphone 1 device to receive or transmit the data 7a, 7b, 7c to an internet-connected base station 13. In one embodiment, the metadata comes from the user portal.

The base station may be a proprietary wireless receiver, or it may be a generic wireless router. The base station may use a number of communication protocols that includes but is not limited to WiFi, LoRa, NB-IoT, and others. The base station 13 is capable of receiving and transmitting scheduled transmissions 12 from a plurality of flow measuring devices 14. The base station then transmits the data 7a, 7b, 7c to a remote server running a server-side application 20 via the internet 15. The separate data streams 7a, 7b, 7c are combined into a single data stream 16 for receipt by the remote server infrastructure 20 and use by the server-side application(s) 24.

Transmission of data may be continuous or may be periodical. For example, the transmission of data in real time may be preferable for the most accurate monitoring. However, it may also be preferable to transmit data only periodically, for example every minute, or hour, or other time period. The system for observing fluid flow may include a programmed routine where the on-device computer-readable storage media is deleted on a rolling basis, meaning that it may re-write over the oldest data to allow for ongoing observation. This poses minimal risk of creating gaps in data, because, if for example, the data is stored or re-written on a 24-hour schedule, and if the periodic transmission schedule is once per hour, then the device would have had at least 23 opportunities to transmit the data to the remove server. According to this embodiment, the device is programmed with a fault-detection routine, which will attempt to re-send data at the next scheduled transmission, if it detects that the data was not received at the prior-scheduled transmission. Having periodic, as opposed to continuous transmissions can save internet bandwidth, and minimize the overall volume of network-access attempts. Especially if the flow monitoring device is connected to the internet and/or remote server via cellular data communications links, minimizing the ongoing occupation of cellular data can save cost both to the user, and minimize its contribution to crowded networks. Employing the use of scheduled periodic transmissions can also maximize the potential for network reliability, because if a scheduled transmission is unsuccessful due to a network failure, then an appreciable amount of time passes before the next attempted transmission, which may provide sufficient time for network maintenance to be performed and allow for the subsequently scheduled transmission to be successful.

According to an embodiment, the routine for periodic transmission routine will be programmed to have an emergency override, and transmit data immediately if the flow monitoring device detects one or more predetermined thresholds, such as the detection of a plumbing failure, such as a toilet tank crack, or inoperative valve. Pursuant to this feature, the remote computer or server will immediately receive the data, and will be able to quickly notify a user immediately upon the happening of an emergency situation. By pairing the periodic transmission routine with the emergency override program, users will enjoy both the benefits of network efficiency, without having to sacrifice the instant notification of an emergency, as would be expected with a continuous-transmission routine.

The transmission of data may also be two-way, with the remote server and remote applications configured to transmit software updates to the flow monitoring device, remotely configure and calibrate the flow monitoring device, access the content of the computer readable storage media of the flow monitoring device, and generally perform remote configuration and maintenance routines on the flow monitoring device.

The server-side application(s) 24 and backend server infrastructure 20 includes a plurality of algorithms and analyses tools, including a flow prediction and improvement engine 17, a cohort development and maintenance routine 18, and a conservation analyzer 19 including benchmark development. The foregoing analytical tools work together to employ machine learning techniques which allow the server-side application to further develop more appropriate and accurate algorithms for measuring fluid flow, identifying appliance and/or fixture usage, and increasing confidence in emergency situations, including the circumstances for sending alerts. An exemplary analytical method is to identify the edges of water flow, meaning that the data is analyzed to determine a zero-flow baseline, and then analyzed to determine a full-flow ceiling. Normal operation would be expected in between the baseline and ceiling determinations. The analytical methods can be further improved by inputting baseline data associated with different building profiles, for example a building with an old pluming system may have different full-flow signatures as compared to buildings with newer plumbing systems. The analytical methods can be further improved by providing circumstance-specific algorithms. For example, an “away” or “vacation” mode may trigger the application of an algorithm with narrower tolerances for concluding a leak or rupture event has occurred, because minimal flow would be expected until the “away” or “vacation” mode is cancelled. Another circumstance-specific algorithm may be applied to filter preexisting external sound. For example, if the pipe flow monitoring device is located on a pipe in close proximity to the floor of a building, the microphone may sense the existence of muffled voices, or footsteps. Likewise, if the sound monitoring device is located on a pipe in close proximity to the outdoors, extraneous noises, such as passing cars, animals, and/or human speech may be detected by the microphone. The analytical methods provided herein may apply circumstance-specific algorithms which correlate to such extraneous sounds and filter them out when compared to known, expected, or predicted fixture flow signatures, thereby minimizing false leak-detection alerts.

The server-side application and backend infrastructure 24 further comprises a notification system 21, and programming for supporting a plurality of user interfaces in the form of a consumer user interface (UI) 22 and a utility (e.g. municipal water utility) UI 23 accessible through remote user portals, such as personal computers or mobile devices. The notification system 21 is configured to send alerts to users reflecting particular system characteristics via a plurality of communication means, such as text messages, email, social media platforms, and automated telephone dialing.

One of the plurality of user interfaces supported by the backend infrastructure and server-side application 20 is a consumer UI 22, which is accessed through digital portal, such as a webpage or mobile application. The consumer UI 22 comprises various menus, displays, and tools. The consumer UI 22 provides a means for user registration, one or more tools for configuring the user's flow monitoring system, such as setting a user's notification preferences, and displays for monitoring consumption, benchmarks, warnings and conservation recommendations. Another of the plurality of user interfaces supported by the backend infrastructure and server-side application 20 is a utility UI 22, which is accessed through digital portal, such as a webpage or mobile application. The utility UI 22 comprises various menus, displays, and tools. The utility UI 22 provides a means for user registration, one or more tools for configuring the user's flow monitoring system, such as setting a user's notification preferences, consumer cohort settings, and displays for monitoring “look-a-like” scenarios, consumption, benchmarks, water appliance usage, warnings and conservation recommendations.

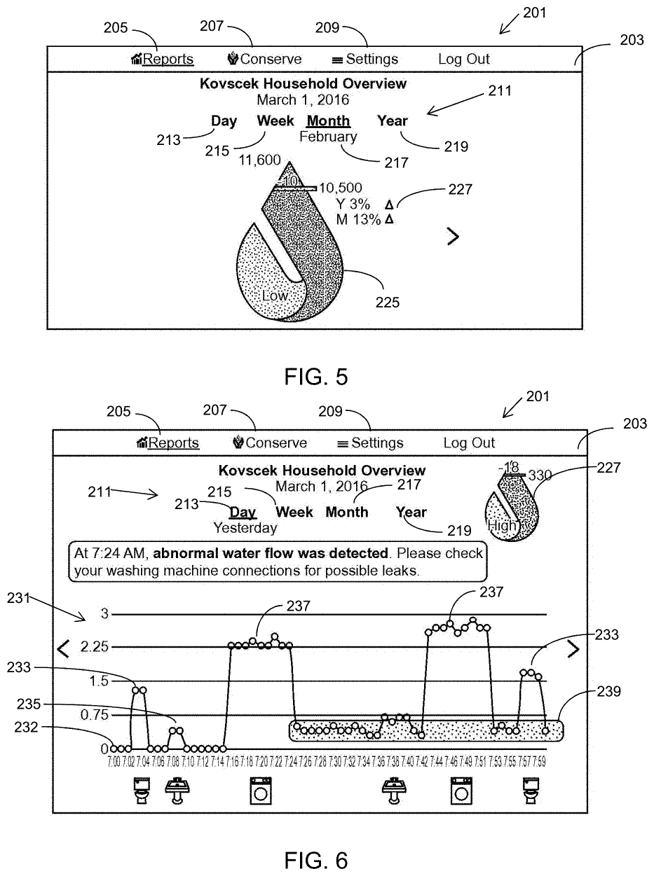

FIG. 5 is a non-limiting embodiment of a user interface 201 for a system for monitoring fluid flow of the present disclosure. FIG. 5 illustrates a summary overview for a month's worth of data monitored by the system. From the user interface 201, a user may access a main menu 203, which may further comprise a plurality menu options, such as a reports 205, conservation recommendations 207, and settings 209 menu options, among others. By accessing any particular menu option, a user may be further permitted to select various information from additional sub-menu options available and categorized according to each main-menu option. For example, illustrated in FIG. 5 within the reports menu option 205, the user interface 201 provides an option for viewing a total household overview according to a plurality of sub-menu options 211, including daily 213, weekly 215, monthly 217, and yearly 219 data selection options. In this respect, the user interface 201 permits a user to access data after it has been categorized by the backend infrastructure and server-side applications.

As disclosed in FIG. 5, for example, a user may view a summary of its monthly water use by first selecting the reports option 205 from the main menu 203, then selecting the month option 217 from the sub-menu, and thereafter choosing the particular month for which the data is desired. As seen in FIG. 5, the user has selected February for its monthly overview. Once particular data is requested by the user, the user interface 201, will display the data in an easy-to read format, such as through written text 221, a data table, or optionally with a graphical representation 225 of the user's data. FIG. 5 shows, for example, a non-limiting graphical representation of monthly water flow for February in the shape of a water droplet graphic, with a line lying horizontally across the water droplet, which is correlated to elevated or decreased use. Within each report, comparative data may be further presented. For example, in FIG. 5, the monthly overview data for February is provided in text 221 and with a graphical representation 225, but further includes comparative analytics 227, which, in this embodiment, show that February's water use was 13% higher as compared to the prior month, and 3% higher than the February of the year prior.

FIG. 6 is a non-limiting embodiment of a user interface for a system for monitoring fluid flow of the present disclosure. The embodiment of FIG. 6 provides a graphical representation 231 of daily fluid flow over a timeline 232, as monitored by the system. Similar to the embodiment reflecting a user's ability to select a month's overview 217 from among the options and sub-options of the main menu 203 of the user interface 201 reflected in FIG. 5, the embodiment of FIG. 6 reflects a user's ability to further navigate to the daily sub-option 213, and further choose which day among many (today, yesterday, any other particular date) for which a report is desired.

Provided in the exemplary user interface 201 embodiment of FIG. 6, a prominent text alert 233 is displayed, notifying a user that abnormal water flow was detected for that day. In this embodiment, the user interface 201 also provides a graphical representation 231 of daily total fluid flow observed at different times throughout the day in the form of a line-chart 231 on a timeline 232. The graphical representation provided in FIG. 6 not only charts flow volume as a function of time, but also provides a graphical representation of the fixture(s) associated with each flow event. The flow association is the result of the application scoring, categorization, and application of analytical tools through the server side application and backend infrastructure for determining a flow signature. Through the application of the methods provided herein, the user interface 201 is able to provide the user with an easy-to-understand graphical representation of flow use associated with each fixture, having been identified through the flow signature of said fixtures.

The chart provided in FIG. 6 shows that early in the morning, at approximately 7:02 am, flow increases from zero to approximately 1.4 gallons, and then quickly decreases back to no-flow. The system identifies this flow signature as a toilet flush 233, having applied the analytical methodology described herein. Shortly after the toilet was flushed, the system detected flow increasing from zero to approximately 0.5 gallons, sustained for a slightly longer period of time, and then returning back to zero flow. Having applied the analytical methodology, provided above, the system identifies this flow signature as a sink 235. Flow later increases to 2.25 gallons and remains sustained at the increased rate for approximately 10 minutes, before again decreasing rapidly at 7:24 am. Having applied the analytical methodology, the system recognizes this flow signature as the filling of a washing machine 237. However, because the water flow did not return to zero after the washing machine flow signature 237 decreased rapidly, an alert was triggered, which indicated that the washing machine was the source of the leak. Similarly throughout the remainder of the time displayed on the timeline, identification of flow is associated with further use of a sink 235, a washing machine 237, and a toilet 233. However, between each of these uses flow did not return to zero, indicating the persistence of a leak 239. Although the total flows for each of the fixtures were higher than what would be expected, the difference in flow as compared to the immediately preceding status was consistent. Thus, the analytical methods of the system concluded that the toilet 233 and sink 235 were functioning properly, but concluded that the washing machine 237 was the most likely source of the leak, because the non-zero flow event began with the expected conclusion of the washing machine flow signature 237.

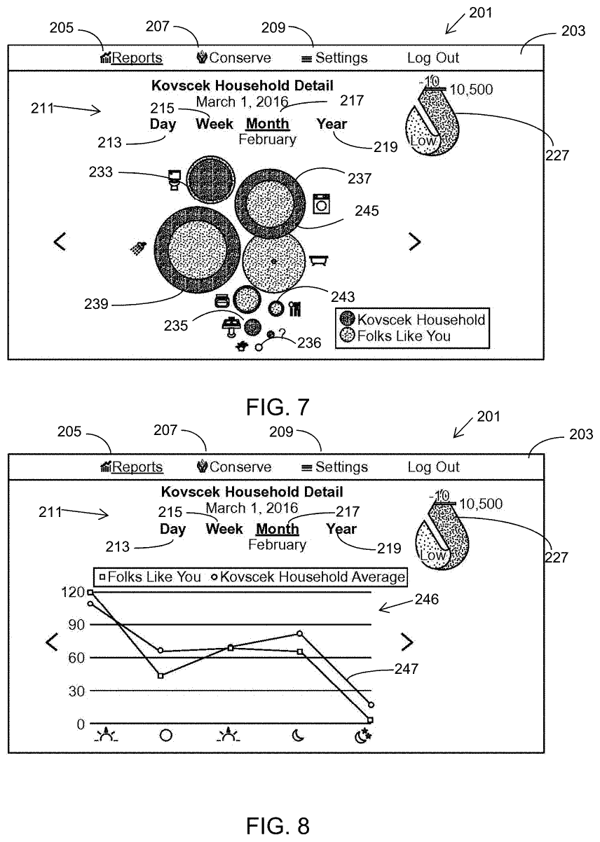

FIG. 7 is a non-limiting embodiment of a user interface 201 for a system for monitoring fluid flow of the present disclosure. The embodiment of FIG. 7 provides a graphical representation 231 of monthly water flow, as monitored by the system, categorized by figure type. The graphical representation 231 for each fixture is scaled comparative to the other fixtures to provide a conceptual illustration of the volume of water use through each fixture. For example, in the month of February, the conceptual representation of flow measured by shower usage 239 was significantly greater than the volume of toilet use 233 as observed by the system. FIG. 7 also provides a graphical representation 231 of bathtub use 241, washing machine use 237, dishwasher use 243, sink use 235, and landscaping use 236.

The embodiment of FIG. 7 further identifies a graphical comparison 245. Although the present disclosure is not so limited, the embodiment of FIG. 7 shows a graphical comparison as being a contrasting overlaid circle for each fixture. The graphical comparison 245 provides a user a further point of reference to compare their use with water use observed in other, similar households. By way of example, the graphical representation 231 of total use and graphical comparison 245 would lead one to conclude that the user of the system of FIG. 7 uses a greater amount of volume on showers 239 as compared to similar households, but uses a significantly less amount of volume on bathtub use 243 as compared to other similar households.

FIG. 8 is an embodiment of a user interface 201 for a system for monitoring fluid flow of the present disclosure. The embodiment of FIG. 8 identifies an exemplary summary overview for a day's worth of data monitored by the system, categorized by volume and time of the day, graphically illustrating the amount of flow measured throughout various times of the day through a line-chart 246. The embodiment of FIG. 8 further reflects a graphical comparison layer 247 line-chart, illustrating flow volume throughout the times of the day, comparative to other data sets.

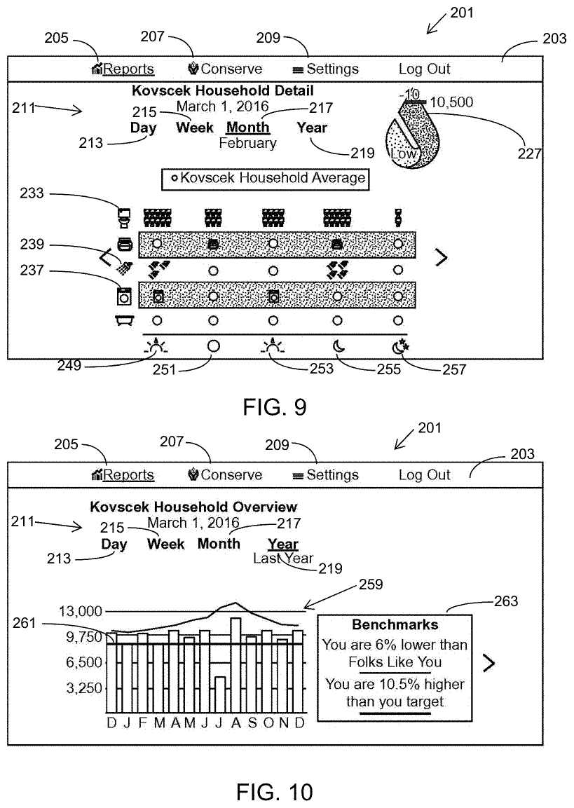

FIG. 9 is an embodiment of a user interface 201 for a system for monitoring fluid flow of the present disclosure. The embodiment of FIG. 9 identifies a summary overview for a month's worth of data monitored by the system, categorized by fixture and volume of flow, comparative to times of the day, graphically illustrating the amount of volume used by various fixtures at times of the day.

The embodiment provided by FIG. 9 shows, for example, that toilet use 233 is heavy in the early morning 249 and evenings 255, with lighter use through the midmorning 251 and afternoon 253, and further with least use at night 257. Comparatively, the graphical representation 231 of the user interface 201 shows that washing machine use 237 in this embodiment is greatest during early morning 249 and afternoon 253. As would be expected, shower use 239 is greatest during early mornings 249 and evenings 255.

FIG. 10 is an embodiment of a user interface 201 for a system for monitoring fluid flow of the present disclosure. The embodiment of FIG. 10 identifies an exemplary summary overview for a year of data monitored by the system. The embodiment of the user interface 201 provided in FIG. 10 shows total water volume per month in a bar chart 259. The user interface 201 may optionally allow a user to set a target usage goal 261, which may be displayed in a graphical representation, such as through a horizontal line across the bar chart. The user interface 201 may further provide a benchmark 263 comparative to a user's usage, by showing annual use by similar households relative to the user's usage on the bar chart. In the embodiment provided by FIG. 10, the benchmark 263 is a line slightly above the data provided by the bar chart, because comparative users annually use more water.

Although the embodiment for the user interface 201 provided by FIG. 10 identifies a bar chart and overlay markers to provide a graphical representation of annualized water flow, the user interface is not limited to such representations, and other graphical representations may also be used.

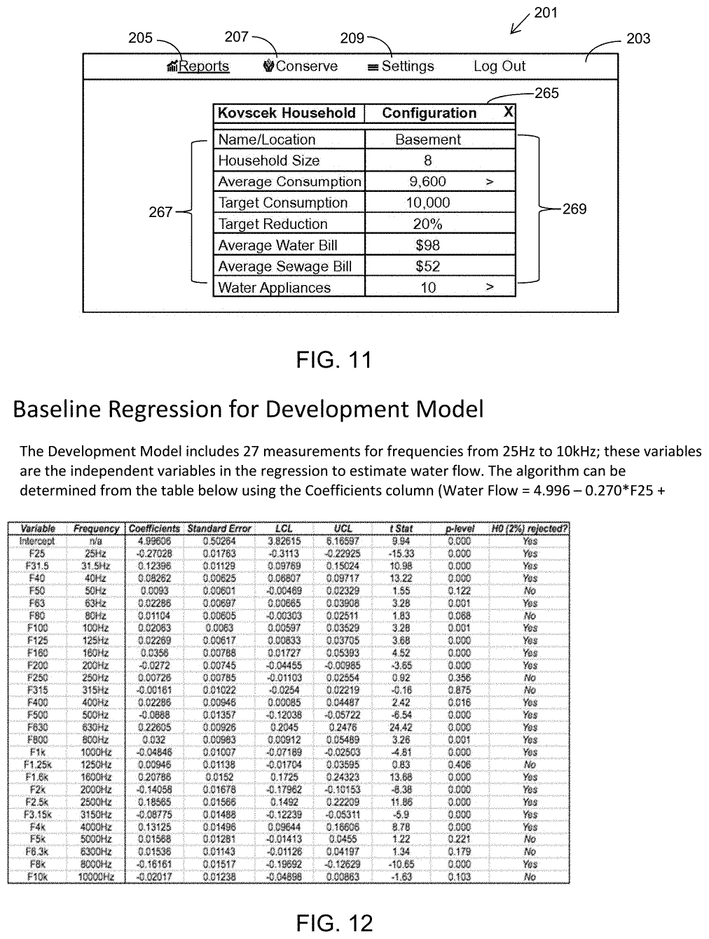

FIG. 11 is an embodiment of a user interface for a system for monitoring fluid flow of the present disclosure. The embodiment of FIG. 11 identifies an exemplary configuration page 265 for managing user-input settings governing the system. The configuration page 265 provides a table with several variables 267 corresponding to different values 269 which can be modified by the user to allow the system to better calibrate its monitoring criteria, and to better apply the algorithms and analytics for providing reports and alerts. For example, the configuration page 265 may allow a user to specify the particular location of a flow monitoring device, such as in the basement, or it may allow a user to input the user's traditional utility bills for water and sewage. From this configuration data, the system will be able to better apply the analytical methods described herein to the data collected by the flow monitoring device.

FIG. 12 is a non-limiting example of developing an algorithm to calculate water flow from the sound measurement across 27 different frequencies. The algorithm defined in this figure is the baseline development model to be used as a foundation and a performance benchmark for additional models or algorithms. In this algorithm, all 27 frequencies are analyzed for performance contribution. In one embodiment, the algorithms are device specific. In another embodiment, the algorithms are cohort specific. In another embodiment, the algorithms are use case specific. In all embodiments, numerous statistical techniques are used and models are developed to identify the best algorithms. Further, in all embodiments, the algorithms are improved over time.

In one embodiment, all frequency measurements are used in the algorithm. In another embodiment, the sound measurements for each frequency with the strongest statistical relationship to fluid flow are used in the algorithm. In one embodiment, the frequency measurements include at least one reading taken on at least 10 different frequencies. In another embodiment, frequency measurements include at least one reading taken on at least 15 or 20 or 25 or 30 or 35 or 40 or 45 or 50 different frequencies. In another embodiment, the frequency measurements include at least two or three or four or five or ten of 15 or 20 readings taken on at least 10 different frequencies.

In one embodiment, the frequencies monitored can be based on the capabilities of the sound detecting device. In one embodiment, the sound detecting device can be a tri-octave band that can generate measurements across approximately 27 different frequencies. In another embodiment, the sound detecting device can be a full octave band that can generate measurements across over 60 different frequencies.

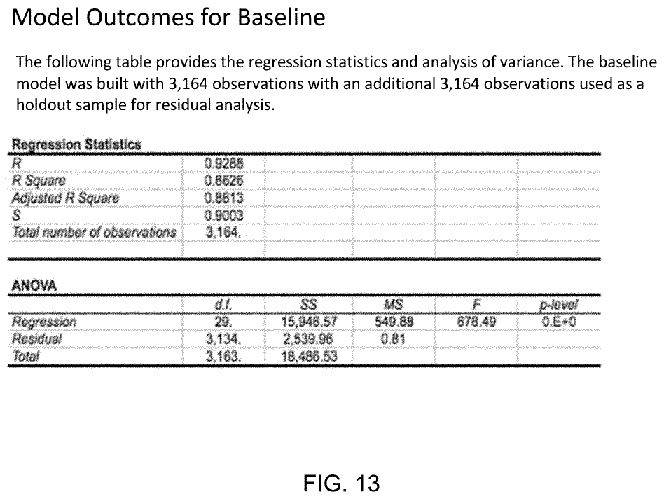

FIG. 13 is a non-limiting example of the model outcomes for the baseline development model associated with FIG. 4. The regression statistics and analysis of variance serve as a benchmark for all embodiments.

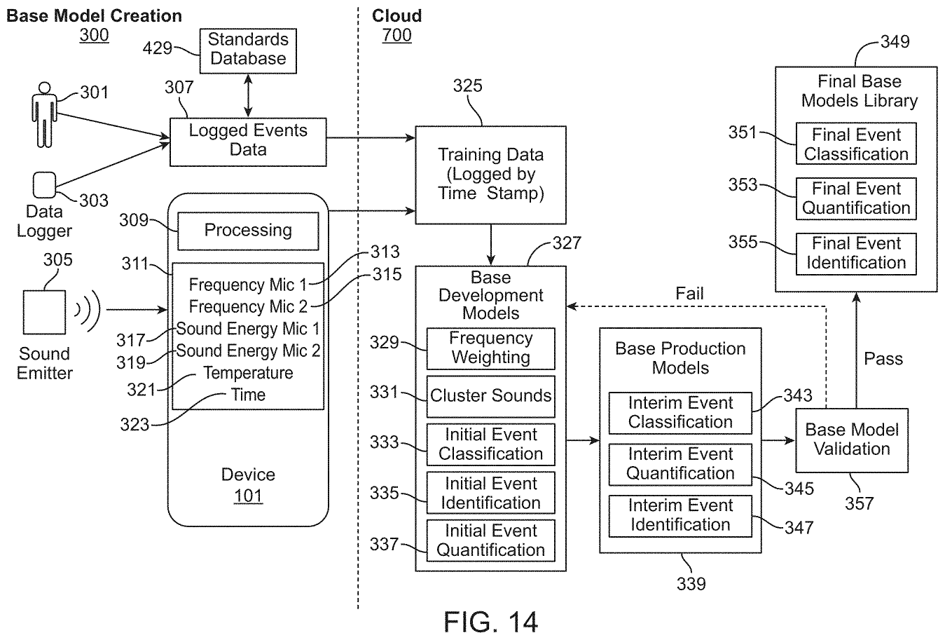

FIG. 14 depicts a schematic illustration of a method for creating Base Models 300 for use in the sound monitoring system. The creation of Base Models 300 of a system for listening to a target object begins in pre-installation environment which may be a laboratory or in a reference location, but in any event is at least partially controlled. Base Model Creation occurs with the collection of training data 325 which is generated in the pre-installation environment where various attributes of the target object (e.g., pipe sizes and materials in a plumbing environment) are known, and which may be optionally obtained from a standards database 429. These known attributes are “dependent variables” which contribute to logged events data 307 which are provided by either an electronic data logger 303 or a technician 301. Alternatively, training data may be collected in various field tests representing different usage environments (e.g., homes, multi-tenant properties, commercial kitchens), but in either event, various attributes (dependent variables) are already known and are incorporated into the logged events data 307 by a technician 301 and/or data logger 303. For example, various events, such as a water start/end, or machine cycle changes, are observed by the technician or data logger and tagged or logged as a function of time according to when they occurred. In the case of a washing machine, a timeline with identified events/functions: filling time, agitation phase, draining, spin cycle, etc.

To create Base Models, training data 325 is first generated by capturing multiple data inputs 311 by the device 101. The device may quantify frequencies observed by the target (or contact) mic 313, the sound energy observed by the target mic 317, frequencies observed by the ambient mic 315, sound energy observed by the ambient mic 319, temperature 321 observed by the temperature sensor, and time 323. These data inputs 311 are “independent variables.” They are not already an attribute known of the target, and are instead observed and created only through the laboratory of field test performed at the time of observation.

Sound frequency is commonly known as pitch and measured in hertz (Hz), whereas sound energy is commonly known as loudness and measured in decibels (dB). However, while the system disclosed herein will record the frequency and energy of sound emitted by the target and environment, application of these variables are not confined to their traditional evaluation. For example, one way in which the disclosed system may consider sound energy is to account for all energies across all frequencies. The system compares the frequencies and energy levels detected by the target mic and compares that to the frequencies and energy levels detected by the ambient mic. If the system recognizes that the energy level detected by the target mic 317 is greater than the ambient energy level detected by the ambient mic 315, it is more likely to be an event performed or triggered by the target. In the case of observing the sound in a pipe, it may mean it is more likely to be a water event and the sound emitted by the ambient mic should be controlled or canceled.

The multiple data inputs 311 then undergo a step of processing 309 and are combined with logged data 307 to become training data 325, which is in effect the combination of dependent and independent variable attributes generated by the target sound emitter 305. Optionally, if logged data (dependent variables) 307 are unavailable or unwanted, the system will rely only on the data inputs (independent variables) 311 to serve as the training data 325.

The target object or sound emitter 305 is the object for which sounds require insight development (e.g., classification and quantification). A typical target object has 5 major categories that capture a large majority (e.g., greater than 80%) of the target market for deployment of the system. For example, in the built environment, the large majority of plumbing systems are represented by about five pipe size and material variations. In this example, the system would require training data to be generated from n=5 objects.

The next step in the method for Base Model Creation 300 is to build a set of Base Development Models 327, which are approaches and algorithms that assess, categorize, and weight input data for entire classes of a target object (e.g., five pipe size and material variations).

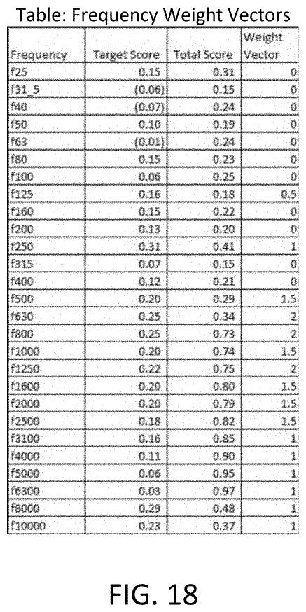

In creating Base Development Models 327, a step of frequency weighting 329 occurs. FIG. 18 reflects an exemplary table illustrating the weighting vector for various frequencies and the associated scores. This examines the range of frequency data collected by the device 101 and determines the frequencies that generate the strongest predictive response to the sound that is emitted by the target object. Weights are created to strengthen the performance of other models. The proprietary approach applies a custom weighting that is learned during the training process. This custom weighting is itself generated through a separate proprietary algorithm that leverages the energy levels from the ambient and contact microphones as surrogates to targeted sound signal emissions (e.g., expected water flow). Each frequency is weighted uniquely based on the relationship to the targeted energy levels of the two mics 313, 315. Through this process we quantify the relative importance that each frequency has to the targeted sound signal and weigh those frequencies accordingly in both the event detection and classification algorithms. Not all frequencies are equally important. The frequency weighting step 329 aims to identify which frequencies are more important. For example, lower to mid frequencies tend to matter more for toilet flush. Higher frequencies tend to matter more for faucets. When the algorithm sees a particular sound signature that tends to be strongly correlated with an event, then that particular sound signature receives additional weight in contributing to the algorithm of the Base Development Models 327. A real-world example may be that every time that a shower has been logged, and there is a unique sound signature correlated with it, the frequency weighting step will weight that sound signature more heavily in the algorithm of the Base Development Models 327.

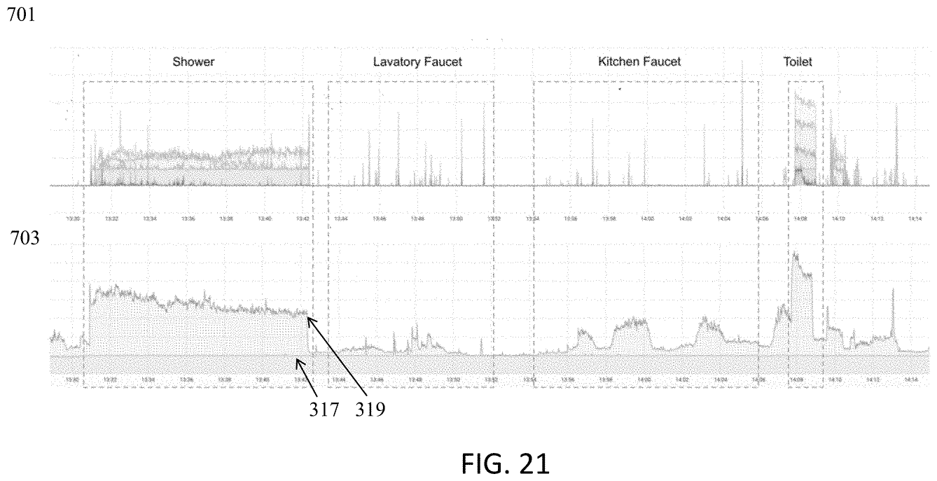

In creating Base Development Models 327, a step of sound clustering 331 occurs. Here, sounds are clustered by the uniqueness of their sound signatures as defined by the range of frequency data for two mics on the device 101. FIG. 21 illustrates example sound signatures from a residential plumbing environment and their associated classifications. In this example, various frequency measurements are provided in the upper chart 701 with energy levels in the lower chart 703. The energy levels for the contact mic 319 are often higher than the ambient mic 317. The pattern of the energy level helps indicate when water is following as well as the nature of the flow. The frequency data pattern provides additional details that provide further data to inform the classification of the signature as well as the clustering, event identification, and event quantification. The machine learning approach for the classification code includes unsupervised clustering techniques such as K-means clustering, but other techniques may also be used. These techniques do not require actuals or dependent variables and create clusters in the form of a nominal scale. Stated differently, the unsupervised clustering 331 performed for Base Development Models 327 draws on training data 325, but only the independent variables 311 are needed. The “unsupervised” clustering refers to the fact that no “dependent” variables are included required. As an example, there are some number of unique sound signatures. Unsupervised clustering 331 identifies those unique signatures and assigns them a nominal score (A, B, C, D). Some will be an event, such as water, while some will not. For example, a sound signature continues for 10 minutes with a particular pattern. The unsupervised clustering step 331 may assign this cluster a nominal score “A,” which is the result of using multiple variables to create the cluster. The sensitivity of the clustering algorithm may be modified to create more or less clusters based on the environment (possibly 30 in a house, but many more in a restaurant). Initially, the unsupervised clustering step 331 errs on the side of identifying or outputting too many clusters, to allow further development which later deletes the ones that aren't target events (e.g., water flow). In a washing machine, there are only about 15 unique sounds a made under normal operation. However, to be effective, the system need to capture those signatures and additionally others in order to also detect a failure.

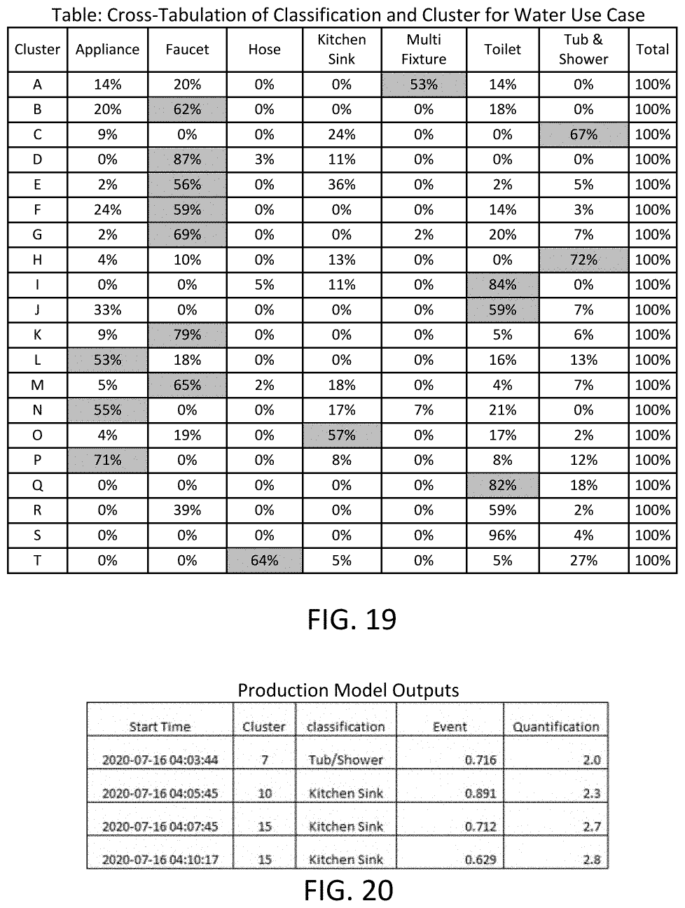

In creating Base Development Models 327, a step of initial event classification 333 occurs. Here, the model identifies the fixture through a correlation with a classification code. This means that there can be a large number of sound signatures. For example in a home, there may be approximately 350 sound signatures in a one-week period. However, only 15-20 of these signatures are unique, meaning they are distinctly similar. Sound signatures are categorized into their known classifications 333, being a descriptive nominal scale. For example, in a plumbing system, the classifications may be shower, faucet, toilet, washing machine, dishwasher. FIG. 19 illustrates the relationship between the Cluster assignment (e.g., A, B, . . . ) and the Classification assignment (e.g., Appliance, Faucet, Hose, . . . ) for a water use application. In this illustration, the highlighted cells indicate the cluster and classification that are most likely the same. Using the training data 325 and independent variables/input data 311, models are built with machine learning techniques such as Decisions Trees and logistic regression algorithms that assign the most probable fixture to each sound signature. The system considers factors such as the frequency patterns and periodicity of the event to improve the classifications and aid in determining the type of event. The unique data engineering of the machine learning algorithm provides insight about the events and the unsupervised clusters 331 and maps those to known fixture classifications from similar environments and installations.

In creating Base Development Models 327, a step of initial event classification 335 occurs. Event identification methods 335 generate a likelihood score that a sound signature is a target event. Event identification considers frequency and sound energy data from the target mic 313, 317 as well as frequency and sound energy data from the ambient mic 315, 319 and assesses energy levels at various frequencies to determine if the observed behavior is more likely from the target object 305 or the environment. Further techniques are used to accurately identify the edges (start and end) of the event. The time series data is analyzed based on the deviation from normal/expected non water sounds (identified during the baselining process). For example, a likelihood score identifies the likelihood is that the event that has been identified is a water event. In an interval scale, for example, a score of 100 means “this is water,” which helps address false positives. This happens through a two step process (1) identify the event and (2) determine that the event is the targeted event (e.g., water event). The event identification process reviews the sound data and finds sounds that match based on a set of parameters set during the training process. Deviations from normal sound indicate the start of an event and are flagged. This step is modeled as a binary relationship in the dependent variable (e.g., 0=no water, 1=water) for every second. Consistent measures of this sound deviation are flagged until the time series of the data returns to normal values, indicating the (water) event has ended. Next, the system determines if it's an event coming from the target (e.g., water) through a series of quantification scores including but not limited to (a) the amount of water flowing, (b) similarity to known water events and (c) similarity to other generated events and (d) the overall energy levels coming from both mics. Consider a gas line or a different water pipe that creates a similar sound but is not the target being observed. This event identification allows the system to know that it's not an event coming from the target. This step is modeled after a logit/binary relationship. The deviation may indicate the start of a water event. Consistent measures of this sound deviation are flagged until the time series of the data returns to normal values, indicating the water event has ended. The process is also applied to identify multiple events

In creating Base Development Models 327, a step of initial event quantification 337 occurs. Here, machine learning methods are also employed to quantify the event 337. Event quantification methods include logistic regression, neural networks, random forest and KG Boost, all of which result in a continuous variable prediction. In water use, the quantification metric may be the rate of water flow (e.g., gallons per minute). The step examines logged data 307, such as flow rate and applies an analysis to generate a continuous variable output model for the applicable target sound emitter 305 (gallons per minute in a residence may range from 0-10 in water, and the health of machines may be 0-100). In machine use, the quantification metrics may include health (e.g., deviation from normal sound signatures) or likelihood to fail (e.g., sound signatures that demonstrate the characteristics of failing components).

The various steps (sound clustering 331, initial event classification 333, initial event identification 335, initial event quantification 337) in creating Base Development Models 327 occur independently of one another. In other words, each of these steps generate algorithms which are collectively, the Base Development Models 327, and do not require any step among them to occur before the other can occur. For example, if the Initial Event Classification 333 step is being run independently of the other operations, it means that classifying occurs based on the training data 325 directly, not the post-weighted, post-clustered data. These steps can also occur multiple times or only once and need not be consistent among them. For example, unsupervised clustering could happen three or four times until a satisfactory result is realized and each of the others only once. Notwithstanding the foregoing, the step of frequency weighting typically occurs first because the weights help inform and improve the other models.

The next step in Base Model Creation 300 is the creation of Base Production Models 339. In creating Base Production Models 339, steps of Interim Event Classification 343, Interim Event Quantification 345, and Interim Event Identification 347 occur. This process of creating Base Production Models 339 integrates the results from the Base Development Models 327 using the independent descriptors of the sound signature (e.g., in water use cases: a rate of flow, a nominal cluster identifier, and a classification of the fixture). A final machine learning approach assesses the quantification metric, nominal clusters and classifications to match and improve the results. As part of this approach, additional contextual circumstances are considered including but not limited to the time of day, day of week, and frequency of nominal clusters. Here, all of the independent, or initial outputs of Base Development Models 327 are cross-referenced among each other, and if they satisfy the Base Model validation criteria 357 they are narrowed down into only the remaining three steps 343, 345, 347. If these models hold, they are promoted to the Post-production Base Model Library 349 and are characterized and stored as algorithms for applying the step of Final Event Classification 351, Final Event Quantification 353, and Final Event Identification 355, all of which complete the process of Base Model Creation 300. FIG. 20 provides example outputs for the Sound Cluster and the Base Production Models.

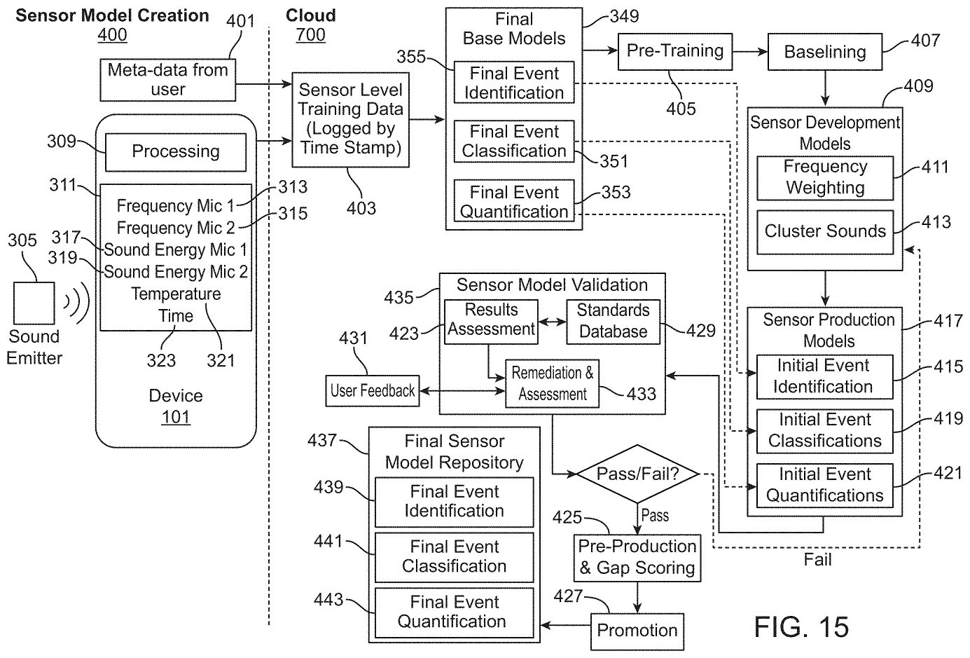

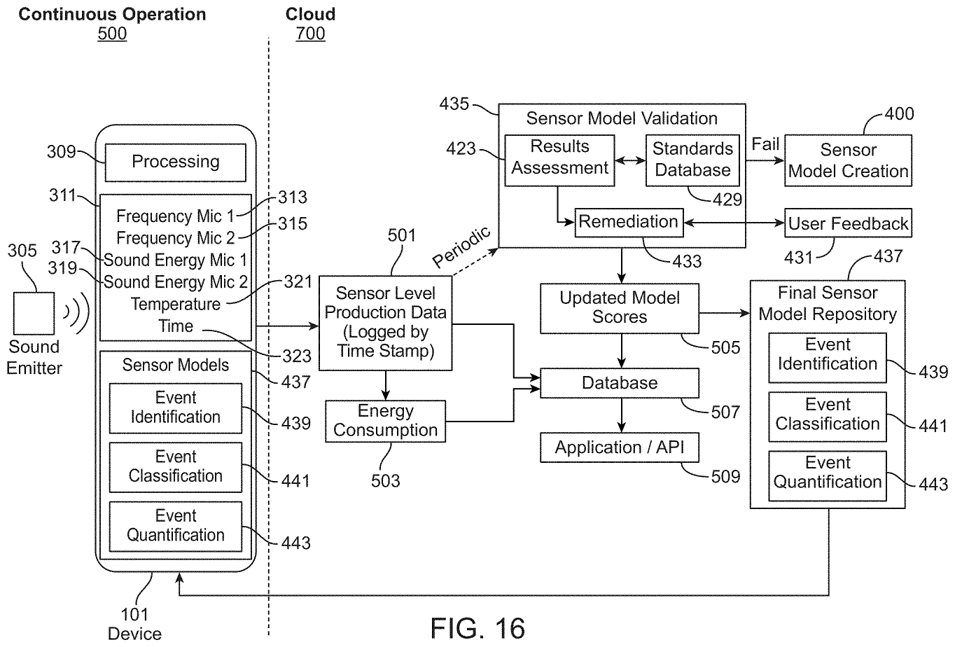

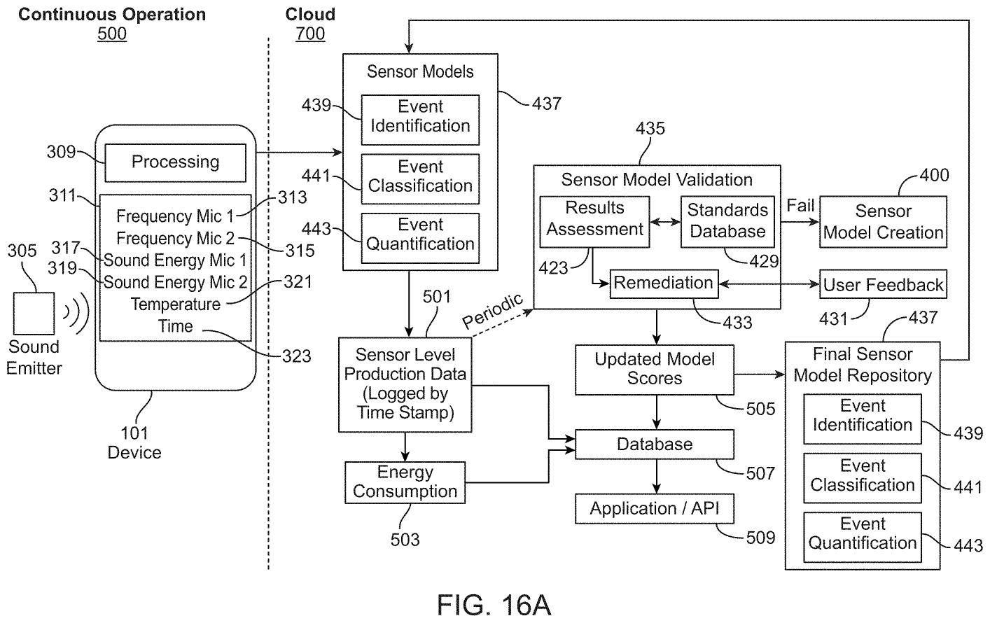

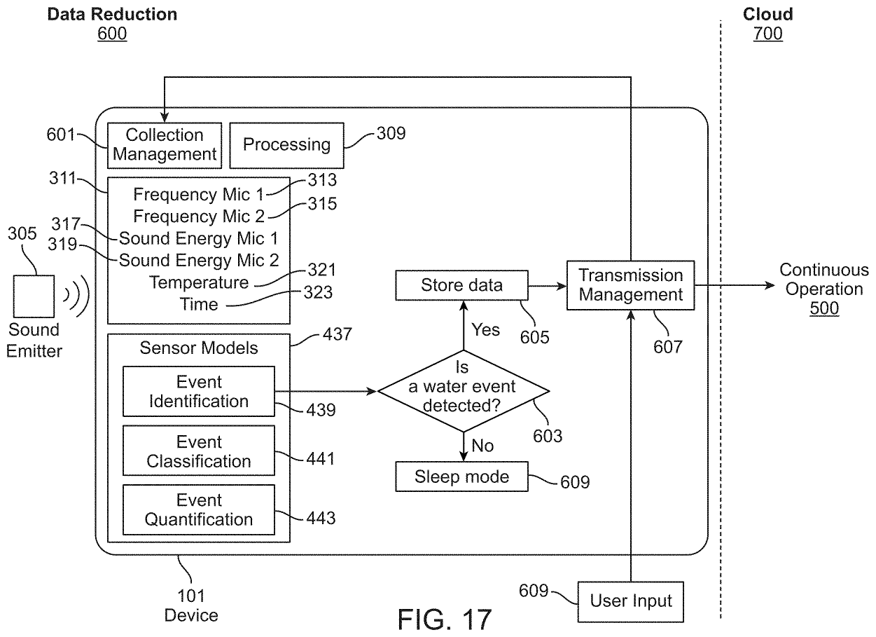

FIG. 15 depicts a schematic illustration of a method for Sensor Model Creation 400 for use in the sound monitoring system. The creation of Sensor Models of a system for listening to a target object occurs in the deployed installation environment, whether a natural, industrial, commercial, or residential location, and is generally not under controlled conditions. Sensor Models are created only for target objects that have production-ready Base Models. The results of Sensor Model Creation is that for each Device 101 “i” in the field, where “i” may be any number between one and the total number of sensors monitoring target objects, there is a set of models that include event identification “i” 439, event classification “i” 441, and event qualification “i” 443 in a final sensor model repository 437. Sensor Model Creation occurs with the application of Base Models 349 from the library built in Base Model Creation 300 in conjunction with the collection of sensor-level training data 403 which is generated in the installed environment. Sensor level training data 325 is generated by capturing multiple data inputs 311 by the device 101. The device may detect frequencies observed by the target mic 313, the sound energy observed by the target mic 317, frequencies observed by the ambient mic 315, sound energy observed by the ambient mic 319, temperature 321 observed by the temperature sensor, and time 323. These data are “training data” since they are used to configure the Base Models and develop the Sensor Models. Basic information is known about the target object such as the pipe size and material, as provided by the user through the installation application. Although no attributes of the target object (e.g., pipe sizes and materials in a plumbing The system applies any metadata 401 provided by the user, to the extent the user has any information to provide about the installation environment. Sensor level training data 403 is collected over a period of time where normal operations or behavior of the target object can be observed. For example, various events, such as a water start/end, or machine cycle changes, are observed by the system and sensor level training data 403 is generated. In many environments, including residential and commercial plumbing systems, this is typically a 7-day data collection period. The data is collected passively with no additional input from the user.

A pre-training routine 405 ensures that the sensor level training data 403 collected meets the expectations for the target object 305 as defined by the Base Models 349 and the category of the target object. The pre-training routine 407 draws on basic data (e.g., meta-data 401) from the user about the target object 305 or environment. For example, if the target object is a plumbing system, the user may identify the size and material of the pipe. The meta-data 401 informs the system of the correct Base Models 349 to select and apply from the library. In other words, this process identifies and selects which event classification, quantification, and identification models 343, 345, 347 to apply from the library 349. The Pre-training routine 405 then tracks the outputs from the application of Base Models 349 over the training period to ensure the sound signatures meet the expectations of the target object 305. For example, if installed on a water system in a residential building, are there at least 30 events in an average day.

Once the pre-training routine 405 is complete, a baselining process 407 establishes the normal state of the distribution of data for each sound frequency. This is accomplished by generating and comparing key statistics, such as minimums, maximums, modes and other univariate statistics, that describe the normal state with respect to the Base Model outputs 439. For example, the mode of each frequency in a residential water system represents no water usage as the most common state of water in a pipe is zero flow. The end result are parameters and coefficients that contribute to the configuration of the Final Sensor Models 437. After baselining 407, each of the frequency data 311 and Base Model outputs 355, 351, 353 are normalized to the specific environment of the target object. For example, once zero flow is known for each frequency, all frequency values are normalized to establish common cross-sensor values. These data generated by baselining 407 are inputs to the Sensor Development Models 409. Similar to the step for creating Base Development Models 327 during base model creation 300 and then Final Base Models 349, similar processes are applied for the normalized, sensor-specific data in the step for creating Sensor Development Models 409 that then finalize the models and create the Sensor Production Models 417, which again are approaches and algorithms that assess, categorize, and weight input data from the target object 305.

In creating Sensor Development Models 409, a step of frequency weighting 411 occurs. This examines the range of frequency data collected by the device 101 and determines the normalized frequencies that generate the strongest response to the sound that is emitted by the target object, but at this juncture, the system also has the Base Models 349 against which to compare. As in the case of creating base models 300 frequency weighting 411 in the context of Sensor Development Models 409 are created to strengthen the performance of other models. The approach applies a custom weighting for each sensor that combines the learning from the Sensor Development Models with the sensor-level frequency response. This custom weighting is itself generated through a separate proprietary algorithm that leverages the energy levels from the ambient and contact microphones as surrogates to targeted sound signal emissions (e.g., expected water flow). Each frequency is weighted uniquely based on the relationship to the targeted energy levels of the two mics. Through this process we quantify the relative importance that each frequency has to the targeted sound signal and weigh those frequencies accordingly in both the event detection and classification algorithms.

In creating Sensor Development Models 409, a step of sound clustering 413 occurs. Here, sounds are clustered by the uniqueness of their sound signatures as defined by the range of frequency data for two mics on the device 101. The machine learning approach for the classification code includes unsupervised clustering techniques such as K-means clustering, but other techniques may also be used. These techniques do not require actuals or dependent variables and create clusters in the form of a nominal scale. Stated differently, the unsupervised clustering 413 performed for Sensor Development Models 409 draws on pretraining data 405, Baselining 407, and Base Models 349, but because all data is being created in an installed environment in the field, only independent variables 311 are being applied. The “unsupervised” clustering refers to the fact that no “dependent” variables are included or required.

In creating Sensor Production Models 417, a step of initial event identification 415 occurs. Here, the initial event identification step 415 first begins with the final event identification model 347 from the Base Model Library 349. Then, in conjunction with the pre-training and baselining data 405, 407, the initial event identification methods 415 generate a likelihood score that a sound signature is a target event. Event identification considers frequency and sound energy data from the target mic 313, 317 as well as frequency and sound energy data from the ambient mic 315, 319 and assesses energy levels at various frequencies to determine if the observed behavior is more likely from the target object 305 or the environment. Further techniques are used to accurately identify the edges (start and end) of the event. The time series data is analyzed based on the deviation from normal/expected non water sounds (identified during the baselining process). For example, a likelihood score identifies the likelihood is that the event that has been identified is a water event. In an interval scale, for example, a score of 100 means “this is water,” which helps address false positives. Consider a gas line or a different water pipe that creates a similar sound but is not the target being observed. This event identification allows the system to know that it's not an event coming from the target. This step is modeled after a logit/binary relationship. The deviation may indicate the start of a water event. Consistent measures of this sound deviation are flagged until the time series of the data returns to normal values, indicating the water event has ended. The process is also applied to identify multiple events.

In creating Sensor Production Models 417, a step of initial event classification 419 occurs. Here, the Final Base Models 349 for event classification 351 are scored with the normalized training data. The result is sound signatures that are categorized into their known classifications 419, being a descriptive nominal scale. Using the training data 403 and independent variables formed from scoring the Base Models 349, models are built with machine learning techniques such as Decisions Trees and logistic regression algorithms that assign the most probable fixture to each sound signature. The unique data engineering of the machine learning algorithm provides insight about the events and the unsupervised clusters 413 and maps those to known fixture classifications from similar environments and installations.

In creating Sensor Production Models 417, a step of initial event quantification 421 occurs. Here, the Final Base Models 349 for event quantification 353 are scored with the normalized frequency data. Using model output data as independent variables, machine learning methods are also employed to improve the quantification of the event 421. Event quantification methods include logistic regression, neural networks, random forest and KG Boost, all of which result in a continuous variable prediction. In water use, the quantification metric may be the rate of water flow (e.g., gallons per minute). The step examines sensor level training data 403, and applies an analysis to generate a continuous variable output model for the applicable target sound emitter 305.

The various steps (frequency weighting 411, sound clustering 413, initial event classification 419, initial event identification 415, initial event quantification 421) in creating Sensor Production Models 409 and Sensor Production Models 417 occur iteratively and will be repeated until results for all models are within the ranges prescribed by the standards database 429 which is determined by a sensor model validation step 435.

Once a sensor is trained through the creation of sensor-level Production Models 417 events are classified 419 and quantified 421 the models move to a staging area for validation 435. In the sensor model validation step 435, the models are processed through a Results Assessment step 423. The Results Assessment step 423 consists of a rules engine that is based on known standards and key performance indicators (KPIs) stored in the Standards Database 429 as determined by the training data 403, third-party research, industry and technical manuals, and prior data and sensor history. During sensor deployment, meta-data 401 is captured to ensure major dimensions are set so that proper standards are applied. For example, if the target object is a water pipe, the system needs to know the pipe size and material (e.g., ¾″ copper) as well as property type (e.g., home, apartment, restaurant). This meta-data 401 will help define the standards that include metrics such as normal or average events per day, length of events by classification, total gallons per day per household member.

The Results Assessment step 423 determines if results meet the criteria required to be promoted 427 into the final sensor repository 437. An example of a failed event includes events that are classified as a toilet event using more than 2 gallons of water. If the deployment is in a residential or commercial setting, the gallons are regulated to be <+1.6 gallons per flush. Results above this limit are flagged for reclassification through a remediation and assessment step 433. If the sensor does not pass, i.e. fails, the Results Assessment step 423, input parameters for training are modified appropriately through remediation 433 and the sensor returns to Sensor Development 409 and Sensor Production 417 for re-training. Re-training parameters are also automated based on the results of the results assessment. For example, if there are too many target events, parameters are increased that will reduce the number of events that get generated. These modifications are again based on a series of alternative default parameters that are defined for each target object.

Once the training results meet expectations on a minimum number of standards or KPI's through the Results Assessment step 423, the sensor data is prepared for promotion 427 through Pre-production and Gap Scoring 425. During pre-production and gap scoring process 425, training parameters are migrated from the Sensor Development Models in a production training environment to the Sensor Production Models in a production scoring environment. This includes input parameters for the machine learning scoring process, objects generated during the training process (e.g., baselines and centroids) through processing 309 and the actual events 311 generated during the training process. Once all scoring parameters are migrated, any scoring production times that were missed during the training process are processed for this sensor (gap scoring). For example, if the sensor is trained on data that ended on Jan. 25, 2021 at 06:00:00 UTC and is being put into production on 1/25/2021 08:00:00, any processes that ran on production sensors during the two-hour window are run for this sensor only. This fills in any processing gaps during the training window. Once pre-production is complete, the last step in the process is the final promotion 427 of the sensor models 437 into the scoring production environment as part of the Sensor Production Models 417. Once all steps are complete and the models are considered final, all data required for use in the production environment are created and stored in the Final Sensor Model Repository 437. The two main steps in this process are (a) populating all event data generated from Training and Gap Scoring into the database tables that populate the user application and (b) to create the control record for production scoring which provides all the information generated from training to the scoring process. The sensor is now considered “in scoring production” and is ready for continuous operation 500 (FIG. 16-16A.)

The Standards Database 429 is a library for target object standards. For example, for water use, the database standards include appliance and fixture standards as well as standards for individual water use in a location to compare observed data versus the standard benchmarks. Further, each major environment has a unique set of model thresholds and parameters that provide an optimal starting point for the Sensor Models. These parameters include items such as the expected percent of time the object is in use (e.g., the percentage of time that water would be flowing). The parameters also include the minimum and maximum length of events and the methods which are used to determine the number of clusters which will be used for unsupervised clustering 413. Similarly, the fixture classification algorithms 419 are unique by major category or vertical. Once results are generated, they are compared to a series of known and recorded benchmarks to determine whether the results are reasonable or whether parameters need to be modified to improve results. The benchmarks are used to create comparisons in the user interface to encourage a change in behavior and to improve algorithm performance. To create more actionable benchmarks, the user interface requests certain information (metadata 401) during the installation process. In a water use case, this may include but is not limited to: number of people in the household, number of fixtures in the location, and use of irrigation.

If during remediation 433, an event remains unclassified (e.g., the nominal cluster assignment 413 does not have a classification assigned 419, then the classification may be “unknown”). This step is designed to address boundary cases that may not have been seen by the system. Boundary cases may be created by a permutation or variation of the target object (e.g., pipe size, type, water pressure, fixture, external events, and other factors). If the system does not recognize an event or cannot achieve a reasonable water flow estimate, the system will categorize the event as “Unknown.” The user may choose to manually classify the event or dismiss the event through User Feedback 431. The system will learn the user-defined classification and apply that to all similar events. Similarly, the user may provide general feedback 431 about the provided water usage information that could further help improve results. For example, the user may provide directional information such as “water use too high” or may provide their monthly usage data as reported by their water utility.

In Pre-production and Gap Scoring 425, all training outputs; for example from events, clusters, classifications, and the corresponding model parameters are loaded and assessed to ensure they meet standards as defined in the Standards Database 429. Since Production Models didn't exist during the training period, Gap Scoring applies the algorithms for the time period from sensor installation and the current time or the time of the last production scoring run.

The algorithms are then Promoted 427. This process generates the control file that puts the data and algorithms that was generated during sensor development creation 400 into the Final Sensor Model Repository 437. The control file ensures the final algorithms 439, 441, 443 and related parameters are properly assigned to the sensor 101, whether via on-board installation, or whether designating them as the Final Sensor Models 437 to remain on the cloud 700 but assigned to that particular device 101 which are then applied in the continuous operation step 500.

FIG. 16 depicts a schematic illustration of a method for continuous operation 500 of a sound monitoring system. The device 101 of the system continually observes sound emitted by the target 305 and generates data through processing 309 including frequency and energy data from one mic 313, 317, as well as frequency and energy data from a second mic 315, 319, temperature data 321 from the temperature sensor, including a timestamp 323. Data is collected from the target object 305 based on the user specifications which may be 24/7 or during specified hours or other timeframes that are meaningful to the collection and evaluation of data from the target object.

An important step in sound processing 309 is noise management and noise cancelation to isolate the sound of the target object from the sound in the environment (e.g., water flow in the pipe versus sounds in the vicinity of the pipe). Because the sensor 101 may optionally have a plurality of microphones, one microphone is oriented in the direction of the target object or optionally in contact with the target object, while another microphone is oriented in a second direction from the target object, optionally on the opposite side of the device and in the direction of the environment, an ambient microphone. The target microphone may be designed with a specialized sound chamber to isolate certain sounds, block others, and more effectively collect sound data at least in the form of frequency 313 and energy 317 measurements from the target object 305. Noise cancelation may take place through processing 309 and occurs in a manner by first identifying and the frequencies 315 and energies 319 observed by the ambient mic and subtracting or removing that data from the frequencies 313 and energies 317 observed by the target mic. There are a number of approaches for nose cancellation well known in the art, and any effective approach may be employed, including for example, time domain acoustic echo cancellation.

In addition to assisting with noise cancelation in processing 309, a multiple-mic system may identify non-target sound signatures from the environment. For example, certain frequencies are indicative of machine sound or human conversation. Identifying and isolating these sounds where they are more pronounced from the ambient mic can further isolate and differentiate target object events and improve the accuracy of sensor level operation data 501. For example, if the target object 305 is a water pipe, the target microphone can be secured against the pipe and the ambient microphone in a direction away from the pipe and towards the environment.

Final sensor models 437 created for the specific sensor 101 are applied to the data 311 to create the event classifications and quantification metrics (i.e., results) called the sensor-level operation data 501. The final sensor models 437 applying sensor event identification models 439, sensor event classification models 441, and event quantification models 443 may be applied locally, on-board at the sensor level through processing 309 as depicted in FIG. 16, or as seen in FIG. 16A, they may be applied to the sound data 311 on the cloud 700, in which case on-sensor processing 309 will still apply some analytics such as sound cancellation. Where sensor level operation data 501 is stored in an operations database 507, they may be delivered to the user and the device 101 via an application or API 509. Regardless of whether final sensor models 437 are applied locally by the sensor 101 (as in FIG. 16) or on the cloud 700 (as in FIG. 16A), they result in sensor level operation data 501.

On a periodic basis (e.g., weekly, monthly, quarterly) or when an anomalous result is identified, the sensor level operation data 501 which are the model outputs, are assessed for drift and assessed for new behaviors through a validation process 435. Model drift refers to the degradation of a model's predictive power due to changes in the environment. If performance degrades, i.e. the sensor level production data fails validation, the system will initiate a new self-learning period through sensor model creation 400 as depicted in FIG. 15. Model performance is assessed and validated 435 by monitoring the predictions and classifications over time, looking for shifts in behavior and comparing to the standards database 429. The Results Assessment 423 compares the sensor level operation data 501 to historic data for the sensor as well as known standards for classification and uses 429. If required, a step of remediation 433 occurs. Updated model scores 505 are then pushed to the final sensor model repository 437 and then for further use by the sensor, either on board, or cloud, meanwhile model outputs are stored on the operations database 507 which is constantly built and from which an application or API 509 draws to provide insights to the user regarding the events of the target object 305.

The sensor-level operation data 501 for the water monitoring use case also includes a step to calculate the energy required 503 to heat water at the installation location of the device 101 through observation of temperature 321 at two points in time and the rate of flow during the interval. The device 101 may include a temperature gauge to monitor for extreme conditions. For example, if the temperature is approaching the freezing point, the user will be alerted of potential freezing conditions. The energy consumption analysis 503 is outputted and stored in the operational database 507 and also sent to the application or available via API 509 for further use by the user or sensor.

Further, the water flow with changes in water temperature is estimated by the changes in temperature to the pipe over a defined period of time is used to estimate the amount of heat generated. This data is used to then estimate the amount of energy required to heat the water. The device provides an estimate of energy consumption 503 for heated water use for the device installation location. For example, If the sensor is located on the hot water outlet pipe of the hot water tank, an estimate for total energy used to heat water for that tank is provided. Data may be provided in real-time or at various time intervals (e.g., hourly, daily, weekly).

The sensor 100 may collect many data dimensions from a plurality of independent microphones every second and can generate several megabytes (MB) of data every day, including actual instances of 30 MB in a day. Significant data usage can be energy and bandwidth intensive, which can limit the potential for installation locations and commercial success. Being able to install the device 101 in a convenient location may mean the absence of an independent energy source, like line or solar power. Accordingly, when the system reduces its energy use, installation with a battery becomes a long-term solution, and the user is given more freedom to install the device in a preferred and discrete location. The system may employ a plurality of techniques to reduce energy and bandwidth consumption through data reduction 600.

The system learns the specific sound signatures 311 for activity for the target object 305 (e.g., water movement in a pipe, a machine turning on). The sensor-level event identification algorithms 439 detect the events. If an event is detected 603 the data is stored 605 and on the sensor 101, which is governed by a transmission management application 607. If no water event is detected the microphone remains in sleep mode 609.

The frequency of data transmission is managed by assessing the usage patterns of the target object through the transmission management application 607. Decreasing the frequency of transmission dramatically reduces data load and energy use. However, data reduction 600 has to be balanced with timely insights and user expectations. The system learns the usage patterns of the target object in its deployment location and adjusts the transmission of data based on usage patterns (e.g., frequent transmission of data during low usage periods is not required) through the transmission management application 607. For example, data is transmitted based on the behavior of water usage in the property. However, if the sensor detects an anomalous use or catastrophic water event, the transmission management application 607 will automatically trigger a data transmission.

Another method for reducing data 600 is frequency reduction. Certain frequencies 313, 317 are more predictive than others in certain situations. Less predictive frequencies may be removed from consideration in the cloud 700, if certain models are applied on-board at the sensor level which serve to remove the less predictive frequencies, data can be reduced, and the device 101 can save processing, energy consumption, and bandwidth. The Sensor Models 437 determines the frequencies that are exhibiting water usage characteristics. These models inform the sensor which frequencies to generate sensor level operation data 501 for, and those for which data should not be generated. The model may be deployed at the edge or the sensor-specific frequencies may be selected via an over the air (OTA) application.

The default periodicity of data collection may be one record per second. Collecting every two seconds reduces the data load by 50%. However, the system needs to balance the data reduction 600 with the accuracy and precision of the results. Frequency of data collection is customized to the individual sensor 101 after the sensor model creation phase 400 and is based on the unique event patterns as determined by the final sensor models 437. The Collection Management 601 routine considers the expected usage of the target object and may collect data at 2 or 3 second intervals or even less frequently; or through user input 609 and alternatively if an event is detected 603, the interval will increase to the default periodicity, for example, one record per second, or even more frequently if needed.

As has been discussed, there are three major steps in the machine learning process employed by the system of this disclosure. First, base models are created 300 in a partially or fully controlled environment through base model development 327 and base model production 339 which his based upon training data 325. The models are developed from major categories of plumbing environment (e.g., pipe size, type, usage environment). Second, sensor models are created 400 in a deployment or install environment, through sensor model development 409 and sensor model production 417, which are based on the application of base models 349 in conjunction with sensor level training data 403 collected for each device 101 in the installed environment. After a specific training period, optionally seven days, sensor model creation 400 continues in an ongoing and iterative loop as continuous operation 500. In continuous operation 500, the final sensor models 437 generate sensor level production data 501 which are stored on an operations database 507 and which are delivered to the user or the device through an application or API. 509. Periodically, the sensor level production data 501 will be put through a validation routine 435 to confirm the accuracy of the sensor models and which permits for updates to the sensor models 437, as well as refinements based on user input. Phases regarding base model creation 300, sensor model creation 400, and continuous operation 500, including validation 435, are mandatory. Refinement based on user input is optional. The refinement based on user input is intended to address edge cases that may not have been seen by the system and can then be marked “unknown” or defined by the user, if the user knows.

In one embodiment, the flow monitoring system is a stand-alone system operated and maintained by an end user. In another embodiment, the sound monitoring system is a service operated and maintained by third party. In another embodiment, the sound monitoring system is a subscription or subscription-like service. In another embodiment, the sound monitoring system is a lease. In the subscription or lease service, the sound monitoring device, processor, and device interface are kept by the end user with the sound monitoring device placed on the end user's pipe. The data is transmitted to a base station and server side infrastructure and application that is held and maintained by the subscription or lease service provider.

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device for identifying the status of a target object by observing sound in the human audible range, comprising:
a housing;
a first microphone mounted in the housing and located in a vicinity of the target object;
a structure comprising a sound-isolating material mounted in the housing;
a processor;
and a power source;
wherein the sound is generated by the target object or the surrounding environment;
wherein the microphone detects a sound in a human audible range in the vicinity of the target object and converts the sound to a digital data; and
wherein the device identifies a status of the target object by applying a plurality of machine learning algorithm to the digital data.

2. The device of claim 1, wherein the sound is generated by the target object and the surrounding environment.

3. The device of claim 1, wherein the first microphone is facing the target object and the structure comprising a sound-isolating material is a sound chamber in contact with the target object.

4. The device of claim 1, further comprising a second microphone that is mounted in the housing, facing away from the target object.

5. The device of claim 1, wherein at least one of the plurality of machine learning algorithms is a base model developed in a pre-installation environment that is at least partially controlled.

6. The device of claim 5, wherein the base model is a category-level model developed for use with a category of target objects being observed.

7. The device of claim 1, wherein at least one of the plurality of machine learning algorithms is a sensor model developed in an installation environment that is not controlled.

8. The device of claim 7, wherein the sensor model is an object-level model developed for specific use with the individual device in the installation environment to observe the target object.

9. The device of claim 1, wherein the application of a plurality of machine learning algorithm to the digital data occurs on a remote server.

10. The device of claim 1, wherein the plurality of machine learning algorithms further comprise:
frequency weighting, which comprises examining the range of frequency data collected and determining the frequencies that generate the strongest predictive response to the sound emitted by the target object;
sound clustering, which comprises using a nominal scale to group the data by the uniqueness of their sound signatures as defined by the range of frequency detected by the microphone;
event classification, which comprises assigning classification codes to the data on a descriptive nominal scale;
event quantification, which comprises assigning a value to the data based on an interval or ratio scale reflecting target object status; and
event identification, which comprises the generation of a likelihood score that the data is a target event.

11. A method for identifying the status of a target object, comprising:
observing sound in a human audible range by a device having a microphone in the vicinity of the target object;
converting the sound to a digital data;
applying a plurality of machine learning algorithms to the digital data; and
identifying the status of the target object;

12. The method of claim 11, further comprising:
detecting target sound by one microphone and ambient sound by another microphone.

13. The method of claim 12, further comprising:
isolating target sound through the use of a sound chamber affixed to the target.

14. The method of claim 11, further comprising
isolating the target sound by comparing energy of the target microphone to the energy of the ambient microphone and subtracting the energy of the ambient microphone.

15. The method of claim 11, further comprising:
developing machine learning algorithms for use with the category of the target object in a pre-installation environment that is at least partially controlled.

16. The method of claim 11, further comprising:
developing machine learning algorithms for use with the specific device in the installed environment which is uncontrolled.

17. The method of claim 11, wherein the application of a plurality of machine learning algorithms to the digital data occurs on the device.

18. The method of claim 11, wherein the application of a plurality of machine learning algorithms to the digital data occurs on a remote server.

19. The method of claim 11, wherein the application of a plurality of machine learning algorithms to the digital data occurs partially on the device and partially on a remote server.

20. A method for reducing the energy consumption of a device for identifying the status of a target object by observing sound in the human audible range, comprising:
observing sound in a human audible range by a device having a microphone in the vicinity of the target object;
converting the sound to a digital data;
determining whether the data reflects an event meriting transmission to a remote server;
deciding through a transmission management application to either transmit the data to a remote server for application of a plurality of machine learning algorithms, or
putting the microphone in sleep mode if the data does not reflect an event meriting transmission.
